(19) United States
(12) Patent Application Publication
(10) Pub. No.: US 2012/0250585 A1
(43) Pub. Date: Oct. 4, 2012

(54) INTERWORKING BETWEEN IMS/SIP AND PSTN/PLMN TO EXCHANGE DYNAMIC CHARGING INFORMATION

(76) Inventors: Swaminathan Seetharaman, Chromepet (IN); Kuldeep Singh, Gurgaon (IN); Durgesh Mishra, Noida (IN)

(21) Appl. No.: 13/384,717

(22) PCT Filed: Jul. 24, 2009
(86) PCT No.: PCT/IN2009/000424

§ 371 Date: Jun. 18, 2012

(51) Int. Cl. H04L 12/16

(52) U.S. Cl. 370/259

(57) ABSTRACT

A method for enabling exchange of dynamic charging information between a calling user and a called user and negotiation of said charging information, wherein the calling user belongs to a public switched telephone network/public land mobile network (PSTN/PLMN) network and the called user belongs to an Internet Protocol (IP) Multimedia Subsystem (IMS)/Session Initiation Protocol (SIP)/Voice over Internet Protocol (VoIP) network. In another embodiment herein, the calling user belongs to an Internet Protocol (IP) Multimedia Subsystem (IMS)/Session Initiation Protocol (SIP)/Voice over Internet Protocol (VoIP) network and the called user belongs to a public switched telephone network/public land mobile network (PSTN/PLMN) network.

### BACKGROUND

1. Technical Field

The present invention relates to communication networks, and, more particularly, to interworking between different types of communication networks to exchange charging related information.

2. Description of the Related Art

Reverse Charging is a service offered to the calling and called users providing the calling user with the means to reverse the call charging at call set-up time or during the active phase of the call. Reverse charging provides the called user with the means to reverse the call charging during the active phase of the call for either the rest of the call or for the entire call. Reverse charging also allows for unconditional reversal of the call charging based on subscription data related to the called user. Reverse charging may be implemented in Public Switched Telephone Networks (PSTN), Public Land Mobile Networks (PLMN), IP Multimedia Subsystem (IMS) or in Session Initiation Protocol (SIP) networks. If the call is between an IMS/SIP network and a PSTN/PLMN network or between two IMS/SIP network users connected by a PSTN/PLMN network or if the call is between two PSTN/PLMN network users connected by an IMS/SIP user charging information may have to be interworked between the calling user and the called user.

Lack of information exchange between IMS/SIP and PSTN/PLMN networks may result in an inability to implement services such as free announcement for SIP user or PSTN user, network charge suppression in IMS/SIP and PSTN for free phone services and reverse charging for a part of the call. If an IMS or a Next Generation Network (NGN) service provider wants to play free announcements to the PSTN/PLMN user, then there is no way to accomplish this. In PSTN/PLMN calls Source Channel Identifier (SCI) may be used to suppress charging at the calling Local Exchange (LEX). SCI represents a channel endpoint on the device sending the request. The information may be carried in the Answer Message (ANM) or the Charging Message (CRG) ISDN User Part (ISUP) and may vary from country to country or depending on the network. An ANM is the off-hook signal sent in the reverse direction indicating that the called party has answered the session request and the billing starts when the answer message is received. ISUP is used in the setting up, management and release of trunks carrying voice and data between the calling and the called parties. Backward call indicators may be used in the Address Complete Message (ACM), Call Progress Message (CPG), Answer Message (ANM) or Connect Message (CON) to indicate to the originating network that the call is not to be charged. An ACM is an ISUP signaling message sent in the backward direction indicating that all the address signals required for routing the call to the called party have been received. A CON is an ISUP signaling message sent in the backward direction indicating that all the address signals required for routing the call to the called party have been received and that the call has been answered. The ANM message may contain a field to indicate which party is to be charged or which party is not to be charged.

In a PSTN/PLMN network backward call indicators in ACM/CPG/ANM messages or in the Connect (CON) message may be used to convey charging related information in Signaling System 7 (SS7) ISUP. Backward call indicators may be interworked in SIP however, the network receiving the backward call indicator should be capable of interpreting the information. Backward call indication is a restrictive mechanism of interworking and may not be extendable to other technologies. In some countries charge number parameter in the Initial Address Message (IAM) may be used to convey charging related information in Signaling System 7 (SS7) ISUP. In some countries Application Transport Message (APM) may be used, but the interworking for APM to IMS/SIP networks has not been defined for charging functionality. Spare bits, in forward call indicators parameter in the IAM message used for indicating collect calls, may be used to convey charging related information in Signaling System 7 (SS7) ISUP. The Remote Operations parameter in IAM, ANM, Release (REL) or in Facility Message (FAC) may also be used to convey charging related information in Signaling System 7 (SS7) ISUP. Network specific mechanism may be used to send the charging relevant information in forward call indicators in PSTN/PLMN networks, and to interwork this information appropriately to IMS/SIP networks. The present mechanisms are not sufficient to interwork the various possibilities that exist today in PSTN/PLMN and IMS/SIP networks.

### SUMMARY

In view of the foregoing, an embodiment herein provides a method for enabling exchange of charging information between a calling user and a called user and negotiation of the charging information, wherein the calling user belongs to a public switched telephone network/public land mobile network (PSTN/PLMN) and the called user belongs to an Internet Protocol (IP) Multimedia Subsystem (IMS)/Session Initiation Protocol (SIP)/Voice over Internet Protocol (VoIP) network, the method comprising of the calling user or the called user sending a request to other user; wherein the request for reverse charging comprises of user to be charged, wherein the user could be the calling user or the called user and content to be charged. The calling user requesting for reverse charging for a session with the called user further comprises steps of the calling user sending a request for reverse charging for the session to the network of the calling user; the network of the calling user sending the request to a network controller present in network of the called user; wherein the network controller is one of a Media Gateway Control Function (MGCF); or a PSTN/PLMN gateway; the network controller including the request, type of content to be charged and user to be charged in an invitation message; the network controller sending the invitation message to a server present in network of the called user; wherein the server is one of an Application Server; or an S-CSCF; or a SIP proxy server; the server validating the invitation message against profile of the called user; the server sending the invitation message to the called user if the called user has not subscribed for reverse charging; the called user sending a response to the invitation message to the server, on accepting the invitation message; the server including an indication that the called user has accepted the invitation message in the response on receiving the response from the called user or if the called user has subscribed for reverse charging; the server sending the response to the network controller; the network controller changing internal state to indicate activation of reverse charging, on receipt of the response; the network controller sending a response to the network of the calling user; and the network of the calling user sending the response to the calling user. The called user requesting for reverse charging when the reverse charging is active for remaining portion of the session or for entirety of the session, further comprises steps of the called user sending a request for reverse charging for the session to a server present in network of the called user, the request including type of content to be charged and user to be charged; and if the request for reverse charging is for entirety of the session, then the request also including an indication that entirety of the session is to be charged; wherein the server is one of an Application Server; or an S-CSCF; or a SIP proxy server; the server validating the request against profile of the called user; the server sending the request to a network controller present in network of the called user, wherein the network controller is one of a Media Gateway Control Function (MGCF); or a PSTN/PLMN gateway; the network controller sending a request for reverse charging to the network of the calling user; the network of the calling user sending the request to the calling user; the network of the calling user sending a response to the request to the network controller, on receiving an acceptance message from the calling user; and the network controller sending the response to the server; the server receiving the response and accepting the response; and the server sending the response to the called user.

Embodiments disclose a method for enabling exchange of charging information between a calling user and a called user and negotiation of the charging information, wherein the calling user belongs to a Internet Protocol (IP) Multimedia Subsystem (IMS)/Session Initiation Protocol (SIP)/Voice over Internet Protocol (VoIP) network and the calling user belongs to a public switched telephone network/public land mobile network (PSTN/PLMN) network or an IMS/SIP/VoIP network, the method comprising of the calling user or the called user sending a request to other user; wherein the request for reverse charging comprises of user to be charged, wherein the user could be the calling user or the called user and content to be charged. The calling user requesting for reverse charging for a session with the called user further comprises steps of the calling user sending an invitation message for reverse charging for the session to a server present in network of the calling user, wherein the invitation message comprises of type of content to be charged and user to be charged and wherein the server is one of an Application Server; or an S-CSCF; or a SIP proxy server; the server validating the invitation message; the server sending the validated invitation message to a network controller present in the network; wherein the network controller is one of a Media Gateway Control Function (MGCF); or a PSTN/PLMN gateway; the network controller sending a request for reverse charging to network of the called party; and the network controller on receipt of a response from network of the called party, sending a response message to the server present in network of the calling party, wherein the response message comprises of the response; the server validating the response message and sending the response message to the calling user. The user requesting for reverse charging when the reverse charging is active for remaining portion of the session or for entirety of the session further comprises steps of the called user sending a reverse charging request for the session to the network of the called user; the network of the called user sending the request to a network controller present in network of the calling user, and the request including an indication that entirety of the session is to be charged if the request for reverse charging is for entirety of the session, wherein the network controller is one of a Media Gateway Control Function (MGCF); or a PSTN/PLMN gateway; the network controllef sending a request to a server present in network of the calling user, wherein the request includes type of content to be charged and user to be charged and if the request for reverse charging is for entirety of the session then the request also including an indication that entirety of the session is to be charged, and wherein the server is one of an Application Server; or an S-CSCF; or a SIP proxy server; the server validating the request against profile of the calling user; the server sending the request to the calling user; the server sending a response to the request to the network controller, on receiving an acceptance message from the calling user; the network controller receiving the response and accepting the response; and the network controller sending the response to the called user through network of the called user. The called user has subscribed for reverse charging for all incoming sessions, the method further comprising steps of network of the called user sending an indication to a network controller present in network of the calling user, wherein the indication indicates a reverse charging request for the current session and the network controller is one of a Media Gateway Control Function (MGCF); or a PSTN/PLMN gateway; the network controller sending a response to the indication; the network controller sending a message to a server present in network of the calling user, wherein the message includes the indication and type of content to be charged and wherein the server is one of an Application Server; or an S-CSCF; or a SIP proxy server; the server checking if the calling user has to verify the indication, on receipt of the indication; the server accepting the indication and storing the indication, if the calling user does not have to verify the indication; and the server sending the indication to the calling user; receiving a response from the calling user and sending the response to the network controller, if the calling user has to verify the indication.

Also, disclosed herein is a method for revoking reverse charging for a session when the session is active, wherein the method comprises steps of a first user belonging to an Internet Protocol (IP) Multimedia Subsystem (IMS)/Session Initiation Protocol (SIP)/Voice over Internet Protocol (VoIP) network sending a request to revoke reverse charging to a server present in network of the first user, wherein the first user is a calling user or a called user and the server is one of an Application Server; or an S-CSCF; or a SIP proxy server; the server forwarding the request to a network controller present in network of the first user, wherein the network controller is one of a Media Gateway Control Function (MGCF); or a PSTN/PLMN gateway; the network controller checking if reverse charging is active for the session; the network controller sending an intimation to the network of a second user belonging to a public switched telephone network/public land mobile network (PSTN/PLMN), wherein the first user is a calling user or a called user; the network of the second user intimating the second user, on receipt of the request; the network of the second user sending a response to the request to the network controller; the network controller sending a response to the request to the server; the server sending the response to the first user; and the server initiating charging of the first user for the session.

Disclosed herein is a method for revoking reverse charging for a session when the session is active, wherein the method comprises steps of a first user belonging to public switched telephone network/public land mobile network (PSTN/PLMN) sending a request for revoking reverse charging to the network of the first user, where the first user is a calling user or a called user; the network of the fust user sending the request to a network controller present in network of a second user belonging to an Internet Protocol (IP) Multimedia Subsystem (IMS)/Session Initiation Protocol (SIP)/Voice over Internet Protocol (VoIP) network, wherein the second user is a calling user or a called user and the network controller is one of a Media Gateway Control Function (MGCF); or a PSTN/PLMN gateway; the network controller forwarding the request to a server present in network of the second user, wherein the server comprises one of an Application Server; or an S-CSCF; or a SIP proxy server; the server informing the second user of the request, on receipt of the request; the server initiating charging of the second user for the session on receipt of a confirmation from the second user; the server intimating the network controller of response of the second user; the network controller intimating the response to the network of the first user; the network of the first user intimating the response to the first user; and the server initiating charging of the second user for the session.

Disclosed herein is a network controller, the network controller belonging to an Internet Protocol (IP) Multimedia Subsystem (IMS)/Session Initiation Protocol (SIP)/Voice over Internet Protocol (VoIP) network and controlling a session between a first user and a second user, the network controller further enabling reverse charging across networks and further comprising atleast one means adapted for including type of content to be charged and user to be charged in an invitation message, when a reverse charging request has been received from a first user; sending the invitation message to the second user; and triggering activation of reverse charging for a session between the first user and the second user, on receipt of a response from the second user. The network controller is adapted to interact with the first user through a server and interact with the second user belonging to PSTN/PLMN network through the PSTN/PLMN network, wherein the first user belongs to an IMS/SIP/VoIP network and wherein the server comprises one of an Application Server; or an S-CSCF; or a SIP proxy server.

Also, disclosed is a server, the server belonging to an Internet Protocol (IP) Multimedia Subsystem (IMS)/Session Initiation Protocol (SIP)/Voice over Internet Protocol (VoIP) network and interfacing in a session between a first user and a second user, the server further enabling reverse charging across networks and further comprising atleast one means adapted for validating an invitation message for reverse charging, against profile of the second user, wherein the first user sends the invitation message; sending the invitation message to the second user if the second user has not subscribed for reverse charging; including an indication that the second user has accepted the invitation message in a response on receiving the response from the second user or if the second user has subscribed for reverse charging; and sending the response to a network controller. The server is adapted to inform charging functions of the reverse charging. The server is adapted to initiate charging according to the response for the session on receipt of the response from the second user.

These and other aspects of the embodiments herein will be better appreciated and understood when considered in conjunction with the following description and the accompanying drawings.

### BRIEF DESCRIPTION OF THE DRAWINGS

The embodiments herein will be better understood from the following detailed description with reference to the drawings, in which:

FIG. 1 is a block diagram illustrating a PSTN/PLMN user calling an IMS/SIP user in accordance with the embodiments herein;

FIG. 2 is a block diagram illustrating a PSTN/PLMN user calling another PSTN/PLMN user through an IMS/SIP network, in accordance with the embodiments herein;

FIG. 3 is a block diagram illustrating an IMS/SIP user calling a PSTN/PLMN user, in accordance with the embodiments herein;

FIG. 4 is a block diagram illustrating an IMS/SIP user calling another IMS/SIP user through a PSTN/PLMN network, in accordance with the embodiments herein;

FIG. 5 is a diagram illustrating a reverse charging request from a calling PSTN/PLMN user to a called IMS/SIP user during call setup, in accordance with the embodiments herein;

FIG. 6 is a diagram illustrating a reverse charging request from a calling PSTN/PLMN user to a called IMS/SIP user after the call is in progress, in accordance with the embodiments herein;

FIG. 7 is a diagram illustrating a call from a PSTN/PLMN user to an IMS/SIP user and the called IMS/SIP user requests for reverse charging after the call is in progress, in accordance with the embodiments herein;

FIG. 8 is a diagram illustrating a call from a PSTN/PLMN user to an IMS/SIP user and the called IMS/SIP user requests for reverse charging for the entire duration of the session after the session is in progress, in accordance with the embodiments herein;

FIG. 9 is a diagram illustrating a call from a PSTN/PLMN user to an IMS/SIP user and reverse charging is requested for the entire call, during call setup, in accordance with the embodiments herein;

FIG. 10 is a diagram illustrating a call from a PSTN/PLMN user to an IMS/SIP user and the request for reverse charging is initiated in the response to the call request, in accordance with the embodiments herein;

FIGS. 11a and 11b are diagram illustrating a reverse charged call from a PSTN/PLMN user to an IMS/SIP user and the calling user wants to revoke the reverse charging, in accordance with the embodiments herein;

FIGS. 12a and 12b are diagrams illustrating a reverse charged call from a PSTN/PLMN user to an IMS/SIP user and the called user wants to revoke the reverse charging, in accordance with the embodiments herein;

FIG. 13 is a diagram illustrating a reverse charging request from a calling IMS/SIP user to a called PSTN/PLMN user during call setup, in accordance with the embodiments herein;

FIG. 14 is a diagram illustrating a reverse charging request from a calling IMS/SIP user to a called PSTN/PLMN user after the call is in progress, in accordance with the embodiments herein;

FIG. 15 is a diagram illustrating a call from an IMS/SIP user to a PSTN/PLMN user and the called PSTN/PLMN user requests for reverse charging after the call is in progress, in accordance with the embodiments herein;

FIG. 16 is a diagram illustrating a call from an IMS/SIP user to a PSTN/PLMN user and the called PSTN/PLMN user requests for reverse charging at the start of the session, in accordance with the embodiments herein;

FIG. 17 is a diagram illustrating an IMS/SIP user to a call from a PSTN/PLMN user and reverse charging is requested for the entire call, after call is in progress, in accordance with the embodiments herein;

FIGS. 18a and 18b are diagrams illustrating a reverse charged call from an IMS/SIP user to a PSTN/PLMN user and the calling user wants to revoke the reverse charging, in accordance with the embodiments herein; and

FIGS. 19a and 19b are diagrams illustrating a reverse charged call from an IMS/SIP user to a PSTN/PLMN user and the called user wants to revoke the reverse charging, in accordance with the embodiments herein.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The embodiments herein achieve a method for interworking between IMS/SIP and PSTN/PLMN networks to allow participants of a communication session to determine the party to be charged for specific media types by dynamically conveying charged party information between IMS/SIP and PSTN/PLMN networks. Referring now to the drawings, and more particularly to FIGS. 1 through 19, where similar reference characters denote corresponding features consistently throughout the figures, there are shown embodiments.

Users of PSTN/PLMN networks and users of IMS/SIP networks may want to communicate with each other and during communication it may become necessary to exchange charging related information between the PSTN/PLMN and the IMS/SIP network. A user of a particular network may dynamically determine that the other user could be charged for the call and the user would then send a request to charge the particular user for the call. The embodiment herein discloses a method of dynamically exchanging charging related information between users of IMS/SIP and PSTN/PLMN networks using the Remote Operations parameter over ISUP. Charging related information may be interworked between a PSTN/PLMN user and an IMS/SIP user to determine the user who to be charged for the call. A user could be charged for the entire call or for a specific part of the call and the users to be charged for particular media types could also be determined.

FIG. 1 is a block diagram illustrating a PSTN/PLMN 103 user calling an IMS/SIP 102 user in accordance with the embodiments herein. The PSTN/PLMN 103 user is the calling user 101 and the IMS/SIP 102 user is the called user 104. The calling user 101 or the called user 104 initiates a request to make the called user 104 as the charged party for the call. The request may be to make the called user 104 as the charged party for the entire call or only for a specific duration of the call. The request may also include details regarding the kind of media for which the called user 104 will be charged.

FIG. 2 is a block diagram illustrating a PSTN/PLMN user calling another PSTN/PLMN user through an IMS/SIP network in accordance with the embodiments herein. The PSTN/PLMN 103 user is the calling user 101 and the called user 104 also belongs to a PSTN/PLMN 103 network. The calling user 101 or the called user 104 initiates a request to make the called user 104 as the charged party for the call. The PSTN/PLMN 103 networks are connected through an IMS/SIP 102 network. The request may be to make the called user 104 as the charged party for the entire call or only for a specific duration of the call. The request may also include details regarding the kind of media for which the called user 104 will be charged. The PSTN/PLMN 103 networks are connected through an IMS/SIP 102 network.

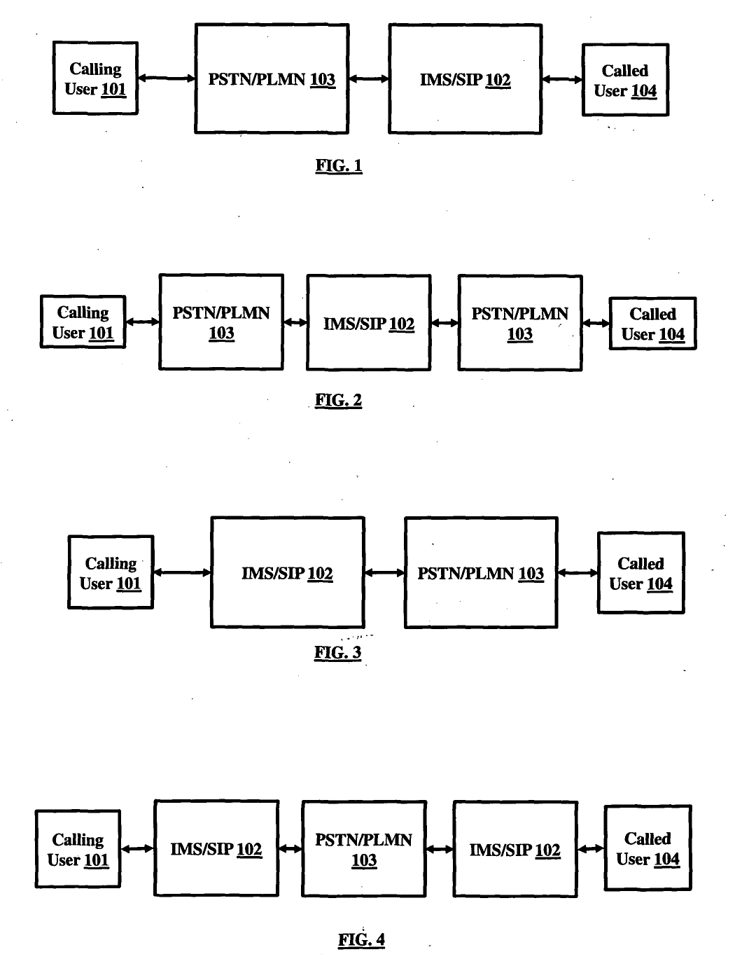

FIG. 3 is a block diagram illustrating an IMS/SIP user calling a PSTN/PLMN user in accordance with the embodiments herein. The IMS/SIP 102 user is the calling user 101 and the PSTN/PLMN 103 user is the called user 104. The calling user 101 or the called user 104 initiates a request to make the called PSTN/PLMN 103 user as the charged party for the call. The request may be to make the called user 104 as the charged party for the entire call or only for a specific duration of the call. The request may also include details regarding the kind of media for which the called user 104 will be charged.

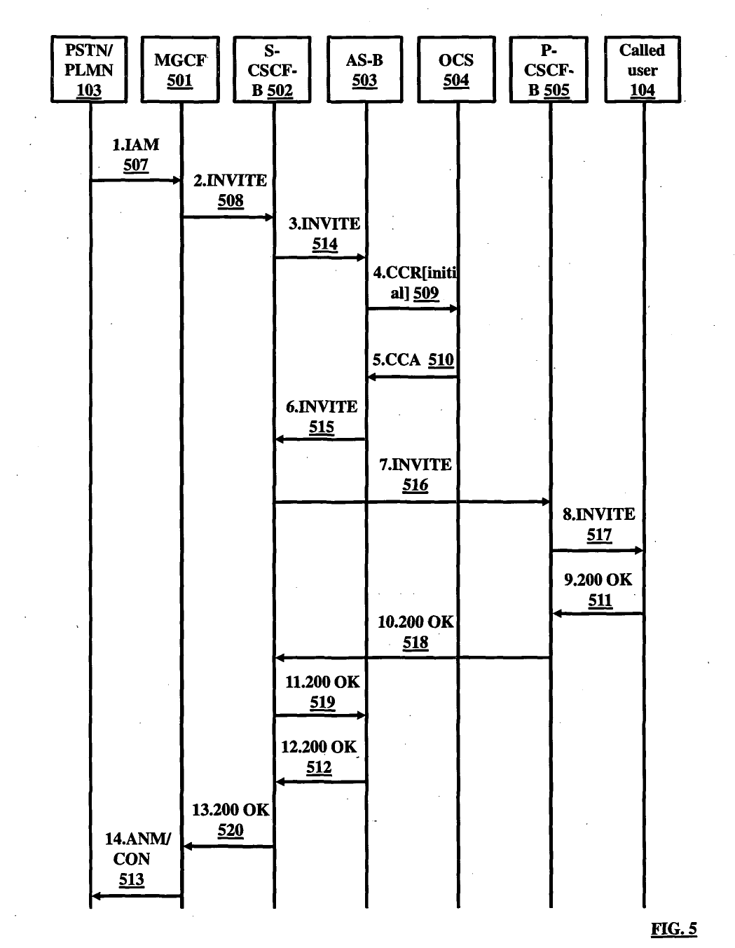

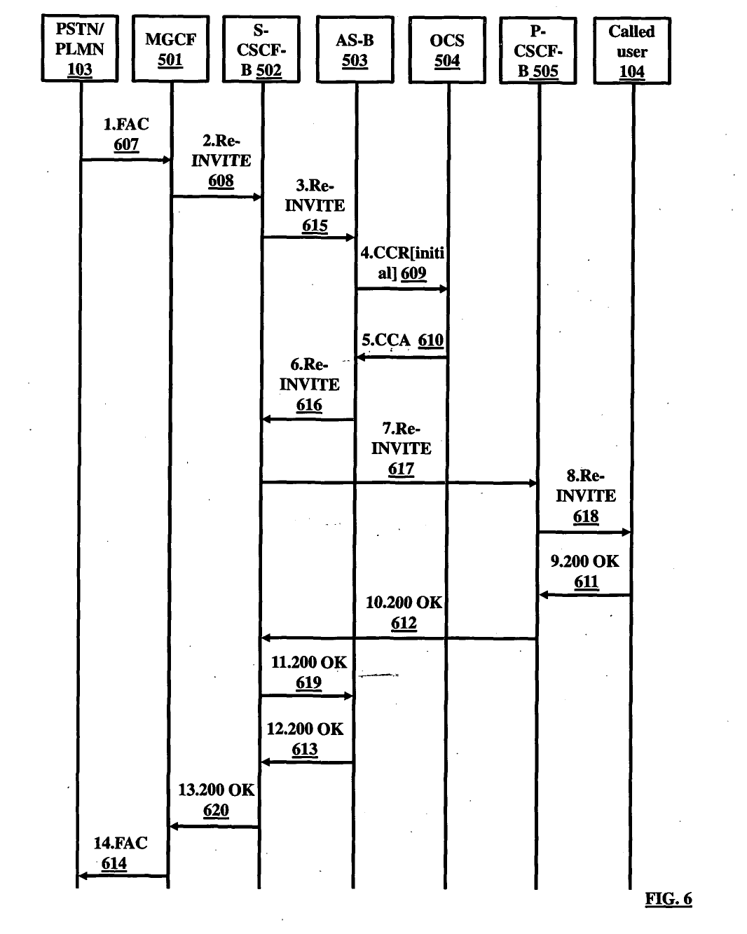

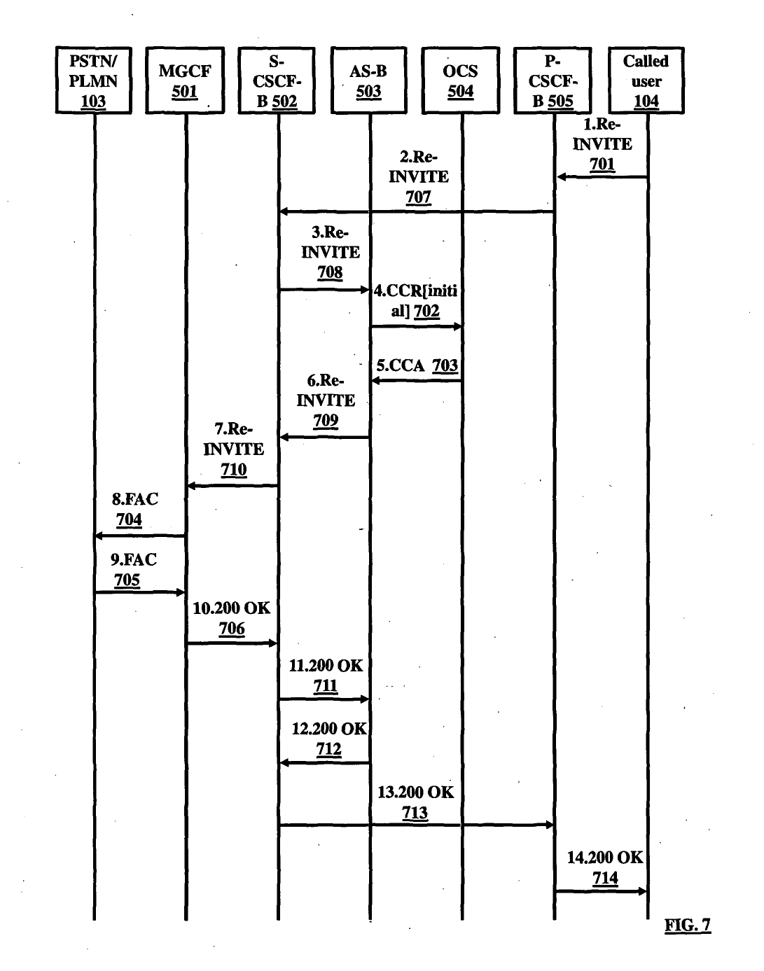

FIG. 4 is a block diagram illustrating an IMS/SIP user calling another IMS/SIP user through a PSTN/PLMN network in accordance with the embodiments herein. The IMS/SIP 102 user is the calling user 101 and the called user 104 also belongs to an IMS/SIP 102 network. The calling user 101 or the called user 104 initiates a request to make the called IMS/SIP 102 user as the charged party for the call. The request may be to make the called user 104 as the charged party for the entire call or only for a specific duration of the call. The request may also include details regarding the kind of media for which the called user 104 will be charged. The IMS/SIP 102 networks are connected through a PSTN/PLMN 103 network.

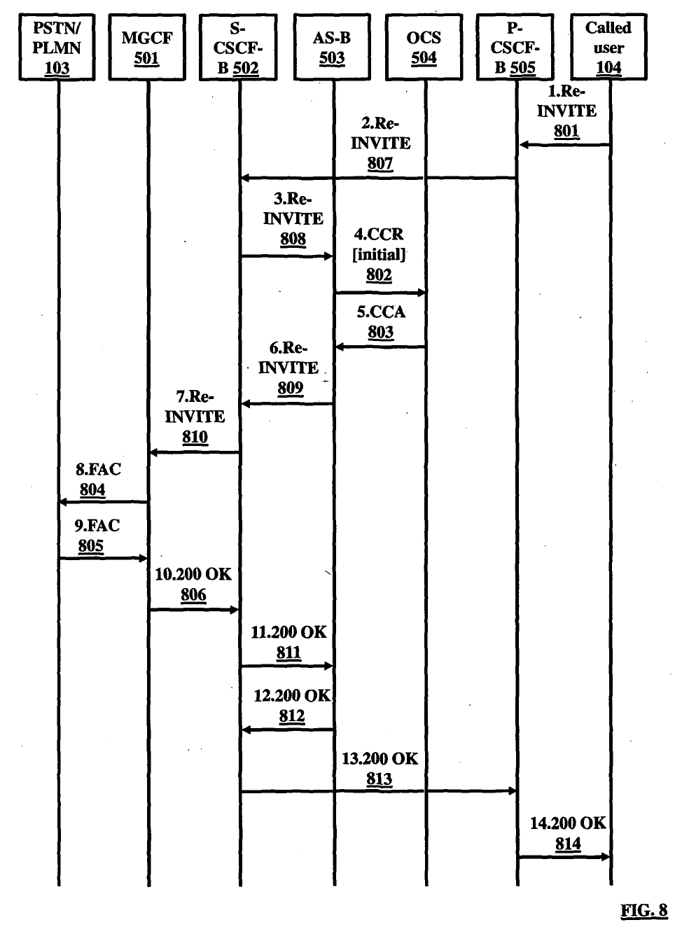

FIG. 5 is a diagram illustrating a reverse charging request from a calling PSTN/PLMN 103 user to a called IMS/SIP 102 user during the call setup, in accordance with the embodiments herein. When the calling user 101 is a PSTN/PLMN 103 user and the called user 104 is an IMS/SIP 102 user and if the calling user 101 wants to request the called user 104 to become the charged party from the start of the call, the calling user 101 sends the request in the initial message during the session setup phase. The initial message includes the parameter with a setup component indicating that reverse charging is requested. The initial message that traverses the PSTN/PLMN may be sent as an Initial address message (IAM) 507 and the setup component may be RevCallingReqSetup invoke component inside the Remote operations parameter. IAM 507 is used to seize a circuit and transfer addressing and call handling or routing information. The IAM 507 may include calling number and the Remote operations parameter. The initial message may be received by the MGCF 501. The MGCF is the functional entity within a network that supports call control functions for distributed switching systems. The MGCF 501 may interwork the initial message to an invitation message and include the media and charging indicator in the invitation message. The invitation message may be the INVITE 508. The media information indicates the media type for which the user would be charged and the charging indicator indicates which user is to be charged for the media type. The media type and the charging indicator may be included as a part of the Session description protocol (SDP). The media type may be indicated by using an attribute ‘m’ in the SDP and the charging indicator may be included as an attribute ‘ci’ in the SDP. If the calling user 101 has to be charged for the call then ‘ci’ would be equal to caller and if the called user 104 has to be charged then ‘ci’ would be equal to called. The invitation message may also mention if the charging function is at the side of the calling user 101 or the side of the called user 104. ‘No Transfer’ mode indicates that the charging function is at the call originating side when reverse charging is invoked and ‘Transfer’ mode indicates that the charging function is at the call destination side when reverse charging is invoked. If the setup component indicates ‘transfer requested’, then the MGCF 501 interworks the calling number to the charge information. The set up component may be RevCallingReqSetup and the RevCallingReqSetup indicates that the reverse charging was requested by the calling user 101 within an IAM. The charge information may be the P-Charge-Info header. The MGCF 501 may then change the charging indicator state to waiting for confirmation from the called user 104, start a timer and then send the invitation forward. The forwarded invitation may be received at the Serving-Call session control function (S-CSCF) 502 of the called user 104. The S-CSCF-B 502 provides session control for subscribers accessing services within an IMS network. The S-CSCF-B 502 may forward the invitation to the serving application of the called user 104. The invitation forwarded may be the INVITE 514. The serving application may be the Application server (AS) 503. An AS 503 is a server that exposes business logic and business processes for use by third-party applications. The AS 503 provides, information and services requested by a remote or a local third-party application. The serving application of the called user 104 may validate the invitation request with the profile of the called user 104. After the profile check if it is determined that the called user 104 has offline charging, then the serving application informs the charging function through an Attribute Value Pair (AVP) in the IMS-Information, about the particular party to be charged for the particular media type. An offline charged user may be a postpaid user and the charging function may be the Charging data function (CDF). The AVP is used to encapsulate protocol-specific data as well as authentication, authorization or accounting information. The new AVP may be included in an accounting request sent towards the charging function. The accounting request may be an Accounting Request (ACR) message. A new grouped AVP type may be included in the IMS-Information in the accounting request. The new grouped AVP type may be a Media-Based-Charging-Info AVP. If the called user 104 has offline charging the serving application sends the accounting request to the CDF. If it is determined that the called user 104 has online charging, then the serving application may inform the charging function through an AVP in the IMS-Information, about the particular party to be charged for the particular media type. A user having online charging may be a prepaid user and for an online charged user the charging function may be the Online Charging System (OCS) 504. The serving application of the called user 104 accepts the invitation message containing the reverse charging request (in the media and charging indicator information) if the called user 104 has offline charging or if the transfer requested field is received as true. The AVP may be included in the credit request towards the charging function and for a user having online charging; the credit request may be the Credit Control Request (CCR) 509. The media based charging information may be a part of the Service-Information AVP in the CCR 509 message. If the called user 104 has online charging, the serving application sends the credit request to the OCS 504. The credit request may be in the form of CCR 509. The OCS 504 sends an acknowledgement back to the serving application. The acknowledgement may be a Credit control answer (CCA) 510. The serving application then sends the invitation to the S-CSCF-B 502. The invitation may be the INVITE 515. The invitation may then be sent to the Proxy-Call session control function (P-CSCF) 505 of the called user 104. The invitation sent to the P-CSCF 505 may be the INVITE 516. The P-CSCF-B 505 of the called user 104 may forward the invitation to the called user 104. The invitation sent by the P-CSCF 505 may be the INVITE 517.

On receiving the invitation from the P-CSCF, the called user 104 can decide to accept or reject the offer. The terminal could consult the called user 104 or decide based on terminal settings whether to accept the offer or reject it before sending the response. If the called user 104 accepts the offer then the called user 104 may send a positive response. The response sent by the called user 104 may be the 200 OK 511. The 200 OK is a SIP final response code indicating a positive response to an incoming request. The response may contain information about the particular party to be charged for the particular media type. The charged party and the media type information may be included in the SDP application body. The response may then be sent to the P-CSCF-B 505 and the P-CSCF-B 505 may forward the response to S-CSCF-B 502. The response sent to the S-CSCF-B 502 may be the 200 OK 518. The S-CSCF-B 502 may then send the response the serving application 503 of the called user 104. The response sent to serving application 503 of the called user 104 may be the 200 OK 519. On receiving the response at the serving application 503 of the called user 104, the transfer accepted indication may be included in the response sent by the serving application 503 towards the MGCF 501 via the S-CSCF-B 502. If the transfer accepted indication is coded as false then the charge information may be included in the response. The response containing the transfer accepted indication is then sent to the MGCF 501 through S-CSCF-B 502 and the response sent to the S-CSCF-B 502 may be the 200 OK 512 and the response sent to the MGCF 501 may be the 200 OK 520. The MGCF 501 maps the transfer accepted indication to the transfer accepted parameter in the return result component of the remote operations in the response message sent towards the PSTN/PLMN. The response message may be the Answer or the Connect message 513, including the remote operations with the Return result component. The remote operations may be the Remote operations parameter. If the transfer accepted indication is coded as false then the charge information may be included in the received response and the charge information may be interworked to include the called number in the return response towards the PSTN/PLMN 103. The charge information may be the P-Charge-Info header. The MGCF 501 then changes its state to indicate reverse charging is active, stops the relevant timer and sends the response towards the PSTN/PLMN 103. The timer was started to wait for the response to the reverse charging request. After the calling user 101 receives the response the call may proceed with the appropriate party being charged for the appropriate media type.

If the called user 104 could subscribe to the reverse charging feature then the serving application of the called user 104 may send the appropriate response to the request based on the profile settings of the called user 104. Instead of determining whether to accept the request based on the profile of the called user 104 the serving application may determine the willingness of the called user 104 to accept the reverse charging through interactive announcements. The interactive announcements may be made through a Media Server. On getting a response from the called user 104 the appropriate response may be sent to the network of the calling user 101.

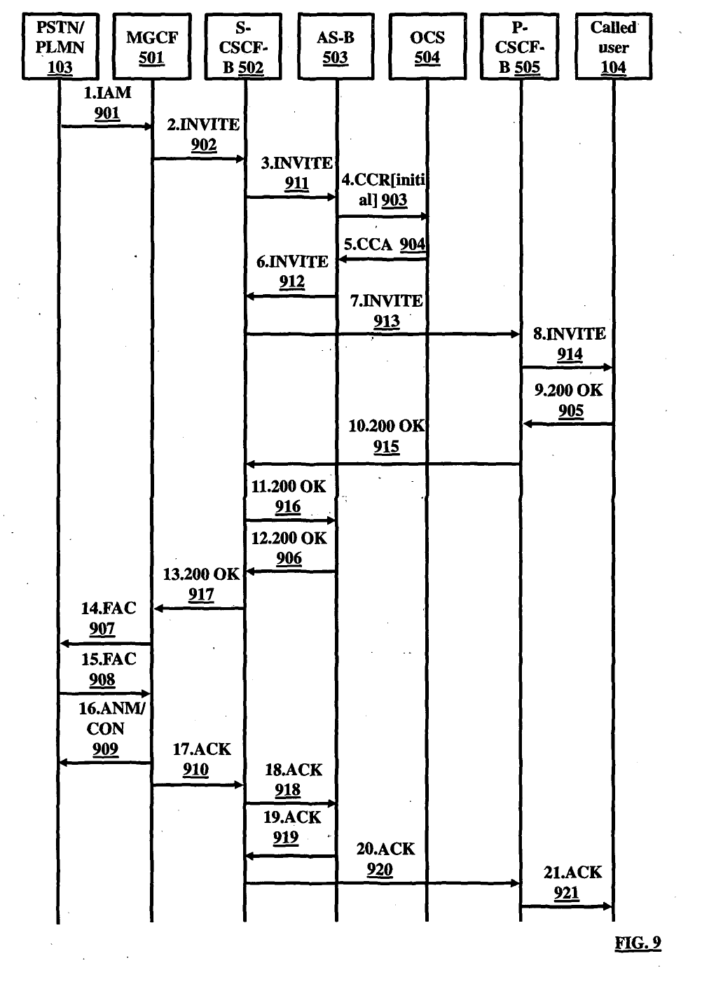

FIG. 6 is a diagram illustrating a reverse charging request from a calling PSTN/PLMN 103 user to a called IMS/SIP 102 user after the call is in progress in accordance with the embodiments herein. When the call is in progress and the calling user 101 is a PSTN/PLMN 103 user and the called user 104 is an IMS/SIP 102 user and if the calling user 101 wants to request the called user 104 to become the charged party after the call is in progress, the calling user 101 sends the request after the session setup phase. The request message includes the parameter with a setup component indicating that reverse charging is requested. The request message may be sent as a Facility Message (FAC) 607. The FAC 607 may include the calling number and the Remote operations parameter with the RevCallingReqActive setup component. RevCallingActive is the setup component that indicates that the reverse charging was requested by the calling user 101 during the active phase of the call. The request message may be received by the MGCF 501. The MGCF 501 may interwork the request message to a re-invitation message and include the media and charging indicator in the re-invitation message. The re-invitation message may be the Re-INVITE 608. The media information indicates the media type for which the user may be charged and the charging indicator indicates the user to be charged for the media type. The media type and the charging indicator may be included as a part of the SDP. The media type may be indicated by using an attribute ‘m’ in the SDP and the charging indicator may be included as an attribute ‘ci’ in the SDP. If the calling user 101 has to be charged for the call then ‘ci’ would be equal to caller and if the called user 104 has to be charged then ‘ci’ would be equal to called. The re-invitation may also mention if the charging function is at the calling user 101 side or at the called user 104 side by indicating the mode as Transfer mode or No Transfer mode. If the setup component in the request message indicated transfer requested, then the MGCF 501 interworks the calling number to the charge information in the re-invitation. The charge information may be the P-Charge-Info header. The MGCF 501 may then change the charging indicator state to waiting for confirmation from the called user 104, start a timer and then send the re-invitation forward. The forwarded re-invitation is received at the S-CSCF-B 502 of the called user 104. The S-CSCF-B 502 provides session control for subscribers accessing services within an IMS network. The S-CSCF-B 502 forwards the re-invitation to the serving application of the called user 104. The serving application may be the AS-B 503. The serving application of the called user 104 validates the re-invitation request with the profile of the called user 104. After the profile check the serving application informs the charging function through an attribute value pair (AVP) in the IMS-Information about the particular party to be charged for particular media type. For a user having online charging the charging function may be the OCS 504. The serving application of the called user 104 accepts the re-invitation message containing the reverse charging request (in the media and charging indicator information) if the called user 104 has offline charging or if the transfer requested field is received as true. The attribute value pair may be included in the credit request and for a user having online charging the credit request may be the CCR 609. Media-based charging information may be a part of the IMS-Information which is in turn part of the Service-Information AVP in the CCR 609 message. If the called user 104 has online charging, the serving application sends the credit request to the OCS 504. The credit request may be in the form of CCR 609. The OCS 504 then sends an acknowledgement back to the serving application. The acknowledgement may be the CCA 610. The serving application then sends the re-invitation to the S-CSCF-B 502. The re-invitation may be the Re-INVITE 616. The re-invitation is then sent to the P-CSCF 505 of the called user 104 and the P-CSCF-B 505 forwards the re-invitation to the called user 104. The re-invitation sent to the P-CSCF 505 may be the Re-INVITE 617 and the re-invitation sent to the called user 104 may be the Re-INVITE 618.

On receiving the re-invitation from the P-CSCF-B 505 the called user 104 can decide to accept or reject the offer. The terminal could consult the called user 104 or decide based on terminal settings whether to accept the offer or reject it before sending the response. If the called user 104 accepts the offer then the called user 104 may send a positive response. The response sent by the called user 104 may be the 200 OK 611 status code. The response may contain information about the particular party to be charged for the particular media type. The charged party and the media type information may be included in the SDP application body. The response is sent to the P-CSCF-B 505 and the P-CSCF-B 505 forwards the response to S-CSCF-B 502. The response sent by the P-CSCF-B 505 may be the 200 OK 612. The S-CSCF-B 502 sends the response to the serving application 503 of the called user 104. The response sent by the S-CSCF-B 502 may be the 200 OK 619. On receiving the response at the serving application 503 of the called user 104 the serving application 503 includes the transfer accepted indication in the response. If the transfer accepted indication is coded as false then the charge information may be included in the received response. The serving application then sends the response to the S-CSCF-B 502 and the response sent may be the 200 OK 613. The S-CSCF-B 502 then sends the response to the MGCF 501 and the response sent to the MGCF 501 may be the 200 OK 620. The MGCF maps the transfer accepted indication to the transfer accepted parameter in the return result component of the remote operations in the response message sent towards the PSTN/PLMN. The charging answer in the received response is interworked by including the remote operations parameter with the return result. The response message may be the FAC message 614 with the remote operations containing the Return result component. The remote operations may be the Remote operations parameter. If the transfer accepted indication is coded as false then the charge information may be included in the received response and the charge information may be interworked to include the called number in the remote operations within the response message towards the PSTN/PLMN 103. The charge information may be the P-Charge-Info header. The MGCF 501 then changes its state to indicate reverse charging is active, stops the relevant timer and sends the response message towards the PSTN/PLMN 103. The timer was started to wait for the response to the reverse charging request. After the calling user 101 receives the response, the call may proceed with the appropriate party being charged for the appropriate media type.

If the called user 104 could subscribe to the reverse charging feature then the serving supplication of the called user 104 may send the appropriate response to the request based on the profile settings of the called user 104. Instead of determining whether to accept the request based on the profile of the called user 104 the serving application may determine the willingness of the called user 104 to accept the reverse charging through interactive announcements. The interactive announcements may be made through a Media Server. On getting a response from the called user 104 the appropriate response may be sent to the network of the calling user 101.

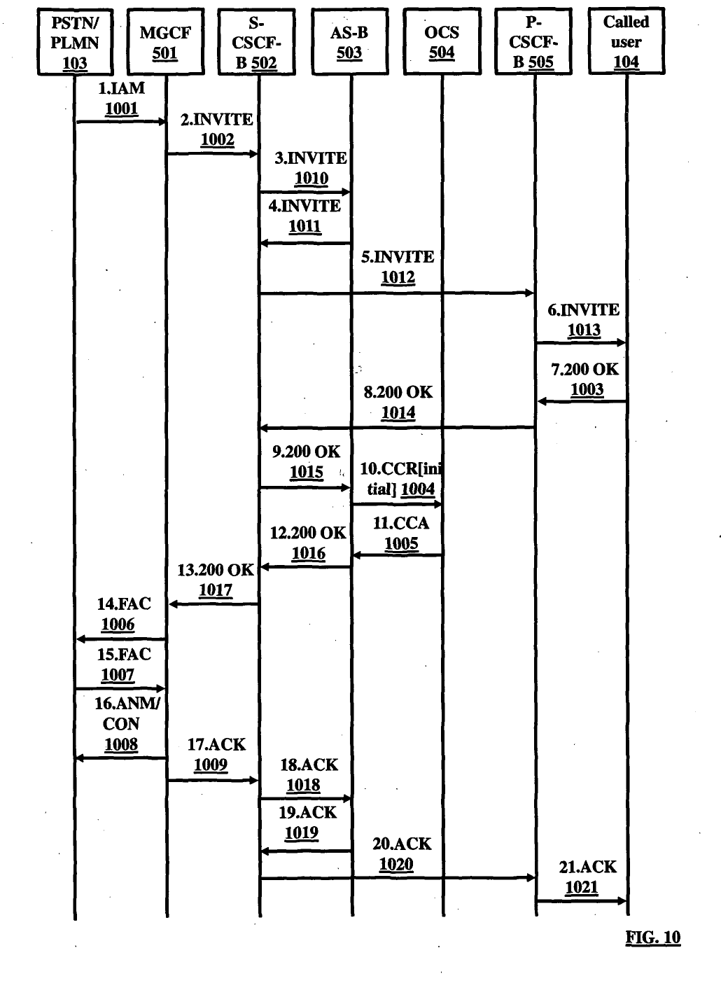

FIG. 7 is a diagram illustrating a call from a PSTN/PLMN 103 user to an IMS/SIP 102 user and the called IMS/SIP 102 user requests for reverse charging after the call is in progress in accordance with the embodiments herein. When the call is in progress and the calling user 101 is a PSTN/PLMN 103 user and the called user 104 is an IMS/SIP 102 user and if the called user 104 wants to request the calling user 101 to become the charged party after the call is in progress, the called user 104 sends the reverse charging request after the session is in progress. The request message may be the Re-INVITE 701 and the re-invitation message may include the media and charging indicator. The media type and the charging indicator may be included as a part of the SDP. The media type may be indicated by using an attribute ‘m’ in the SDP and the charging indicator may be included as an attribute ‘ci’ in the SDP. If the calling user 101 has to be charged for the call then ‘ci’ would be equal to caller and if the called user 104 has to be charged then ‘ci’ would be equal to called. The re-invitation is sent to the P-CSCF-B 505 of the called user 104. The re-invitation is then forwarded to the serving application 503 of the called user 104 through the S-CSCF-B 502. The re-invitation message sent to the S-CSCF-B 502 may be the Re-INVITE 707 and the re-invitation message sent to the serving application 503 of the called user 104 may be the Re-INVITE 708. If the identity of the user being charged currently is different from the identity of the called user 104, then the serving application includes the charge information with the identity of the number to be charged. The serving application of the called user 104 validates the re-invitation request with the profile of the called user 104. After the profile check the serving application may inform the charging function through an AVP in the IMS-Information about the particular party to be charged for particular media type. For a user having online charging the charging function may be the OCS 504. The attribute value pair may be included in the credit request and for a user having online charging the credit request may be the CCR 702. Media based charging information may be a part of the IMS-Information which is in turn part of the Service-Information AVP in the CCR 702 message. If the called user 104 has online charging, the serving application sends the credit request to the OCS 504. The credit request may be in the form of CCR 702. The OCS 504 sends an acknowledgement back to the serving application 503 and the serving application 503 sends the re-invitation to the S-CSCF-B 502. The acknowledgement may be a CCA 703 and the re-invitation sent to the S-CSCF-B 502 may be the Re-INVITE 709. The S-CSCF-B 502 forwards the re-invitation to the MGCF 501. The re-invitation sent to the MGCF 501 may be the Re-INVITE 710. The MGCF 501 interworks the re-invitation message to a message (towards the PSTN/PLMN 103) containing the remote operations parameter with the RevCalledRequest component and also indicates that the reverse charging is not applicable for the complete duration of the call. The transfer requested field may be indicated as true in the RevCalledRequest component. The MGCF 501 then changes the charging indicator state to waiting for confirmation from the calling user 104, starts a timer and then interworks the re-invitation to the PSTN/PLMN 103 network of the calling user 101. The interworked message may be the FAC 704.

On receiving the FAC message from the MGCF 501 the calling user 101 or the calling user's network 103 can decide to accept or reject the offer. The terminal could consult the calling user 101 or decide based on terminal settings whether to accept the offer or reject it before sending the response. If the calling user 101 accepts the offer then the calling user 101 may send a positive response to the PSTN/PLMN 103. The response sent by the PSTN/PLMN 103 to the MGCF 501 may be the FAC 705. The response may contain the return result in the remote operations parameter. On receiving the response at the MGCF 501, the MGCF 501 interworks the response to a positive acknowledgement and includes information about the particular party to be charged for the particular media type. The charged party and the media type information may be included in the SDP application body. The acknowledgement may also mention if the charging function is at the calling user 101 side or at the called user 104 side by indicating the mode as Transfer mode or No Transfer mode. If the received response indicates transfer accepted, then the MGCF 501 interworks the calling number to the charge information. The charge information may be the P-Charge-Info header. The relevant timer that was started to wait for the response to the reverse charging request is stopped. The MGCF 501 then sends the acknowledgement to the S-CSCF-B 502. The acknowledgement sent by the MGCF 501 may be the 200 OK 706 message. The S-CSCF-B 502 then forwards the acknowledgement to the serving application 503 of the called user 104. The response sent to the serving application 503 of the called user 104 may be the 200 OK 711 message. On receiving the acknowledgement, the serving application 503 of the called user 104 accepts the acknowledgement if the called user 104 has only offline charging or if the transfer accepted field is indicated as true. The acknowledgement is then sent back to the S-CSCF-B 502 and the S-CSCF-B 502 sends the response to the P-CSCF-B 505 of the called user 104. The acknowledgement sent to the S-CSCF-B 502 may be the 200 OK 712 message and the acknowledgement sent to the P-CSCF-B 505 may be the 200 OK 713 message. The P-CSCF-B 505 of the called user 104 may send the acknowledgement to the called user 104. The acknowledgement sent to the called user 104 may be the 200 OK 714 message. The call may then proceed with the appropriate party being charged for the appropriate media content. If the answer is not accepted then the scenario is handled as an exceptional scenario.

FIG. 8 is a diagram illustrating a call from a PSTN/PLMN 103 user to an IMS/SIP 102 user and the called IMS/SIP 102 user requests for reverse charging for the entire duration of the session after the session is in progress, in accordance with the embodiments herein. When the calling user 101 is a PSTN/PLMN 103 user and the called user 104 is an IMS/SIP 102 user and if the called user 104 wants to request that the called user 101 becomes the charged party from the start of the call, the called user 104 sends the request after the session is established. The media and charging indicator may be included in the request message. The request message sent may be a Re-INVITE 801. The media type and the charging indicator may be included as a part of the SDP. The media type may be indicated by using an attribute ‘m’ in the SDP and the charging indicator may be included as an attribute ‘ci’ in the SDP. If the calling user 101 has to be charged for the call then ‘ci’ would be equal to caller and if the called user 104 has to be charged then ‘ci’ would be equal to called. An attribute may be included in the SDP application body to indicate that the reverse charging may be for the entire session. The request message is sent to the serving application of the called user 104 through the P-CSCF-B 505 and the S-CSCF-B 502. The re-invitation message sent from the P-CSCF-B 505 to the S-CSCF-B 502 may be a Re-INVITE 807 message and the re-invitation message sent from the S-CSCF-B 502 to the serving application may be a Re-INVITE 808 message. The serving application of the called user 104 may be the AS-B 503. On receiving the request, the serving application of the called user 104 validates the re-invitation request with the profile of the called user 104. After the profile check if it is determined that the called user 104 has online charging, then the serving application contacts the charging function for reserve unit request. On receiving the reserve unit request the charging function may reply to the serving application by sending a reserve unit response. On receiving the reserve unit response the serving application sends a debit unit request to the charging function. The debit unit request is sent to debit the units corresponding to the call duration already elapsed. The charging function responds to the debit unit request by sending a debit unit response to the serving application after debiting the units corresponding to the call duration already elapsed. The charging function may be the OCS 504, the reserve unit request and the debit unit request may be sent in the CCR 802, the reserve unit response and the debit unit response may be sent in the CCA 803. The serving application may also send the debit unit requests to the charging function after receiving the duration information in the response from the calling user 101 or the PSTN/PLMN 103 to the request sent towards the calling PSTN/PLMN user 101. After the entire set of reserve units and debit units operations are completed the serving application sends the re-invitation request to the MGCF 501 through the S-CSCF-B 502. If it is determined that the called user 104 has offline charging, then the serving application sends the alternate charged party identity to the charging function. The message sent to the charging function may also have a field indicating that reverse charging is for the entire session. The duration and the starting time of the session may also be sent to the charging function. The charging function in case the called user 104 has offline charging may be the CDF, and the message sent to the charging function in this case may be the ACR and the response sent by the charging function to the serving application may be the ACA. The serving application sends, the re-invitation to the MGCF 501 through the S-CSCF-B 502. The re-invitation sent to the S-CSCF-B 502 may be the Re-INVITE 809 and the invitation sent to the MGCF 501 may be the Re-INVITE 810. The MGCF 501 interworks the re-invitation message to a message (towards the PSTN/PLMN 103) containing the remote operations parameter with the RevCalledRequest component. The transfer requested field may be indicated as true in the RevCalledRequest component. The MGCF 501 then changes the charging indicator state to waiting for confirmation from the calling user 101, starts a timer and then interworks the re-invitation to the PSTN/PLMN 103 network of the calling user 101. The interworked message sent to the PSTN/PLMN 103 network may be the FAC 804.

On receiving the FAC message from the MGCF 501, the calling user 101 can decide to accept or reject the offer. The terminal could consult the calling user 101 or decide based on terminal settings whether to accept the offer or reject it before sending the response. If the calling user 101 does not accept the offer, then an error response is sent. If the calling user 101 accepts the offer then the calling user 101 replies by sending a positive response. The response contains the return result in the remote operations parameter. The duration for which the reverse charging will be applicable may be included in the return result. The response message sent to the MGCF 501 by the calling PSTN/PLMN 103 may be the FAC 805 containing the remote operations parameter. On receiving the response at the MGCF 501, the MGCF 501 checks to determine if the timer has expired. If the timer has expired an error response is sent. Otherwise, the MGCF 501 interworks the response to a charging answer. The response may mention if the charging function is at the calling user 101 side or at the called user 104 side by indicating the mode as Transfer mode or No Transfer mode (through the transfer accepted indication). If the return result component indicates transfer accepted, then the MGCF 501 interworks the calling number and the duration present in the return result component to the charge information and the duration parameters respectively. The charge information may be the P-Charge-Info header. The duration parameter may be included as part of the SDP application body. The MGCF 501 includes the charging answer in an acknowledgement and sends the acknowledgement forward to the serving application 503 of the called user 104 through the S-CSCF-B 502. The response sent to the S-CSCF-B 502 may be a 200 OK 806 message and the response sent to the serving application 503 from the S-CSCF-B 502 may be a 200 OK 811 message. On receiving the acknowledgement the serving application compares the duration in the SDP application body with the internally computed duration. If there is a difference between the duration in the SDP application body and the internally computed duration, the serving application informs the charging function about the difference. The acknowledgement is then sent to the called user 104 through the S-CSCF-B 502 and the P-CSCF-B 505 and the call then proceeds with the called user 104 being charged for the call. The acknowledgement sent to the S-CSCF-B 502 may be a 200 OK 812 message, the acknowledgement sent to the P-CSCF-B 505 may be a 200 OK 813 message and the acknowledgement sent to the called user 104 may be a 200 OK 814 message.

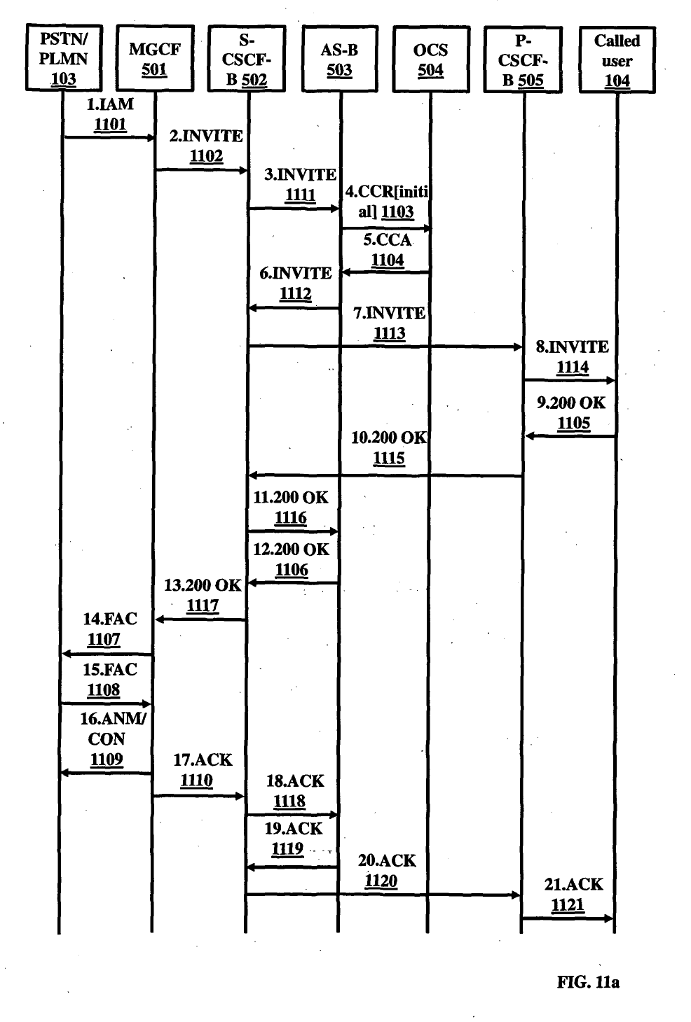

FIG. 9 is a diagram illustrating a call from a PSTN/PLMN 103 user to an IMS/SIP 102 user and reverse charging is requested for the entire call, during the call setup, in accordance with the embodiments herein. When the calling user 101 is a PSTN/PLMN 103 user and the called user 104 is an IMS/SIP 102 user and if reverse charging is requested for the entire call, then the request for reverse charging may be sent during the session setup phase. In this case the called user 104 may have subscribed for reverse charging for all incoming requests or for selective charging depending on the calling user 101 or depending on the services invoked. The initial message for the session setup will be received by the MGCF 501. The initial message may be the IAM 901. The MGCF 501 interworks the initial message to an invitation message and forwards the invitation message to the serving application of the called user 104 through the S-CSCF-B 502. The invitation message sent to the serving application of the called user 104 may be the INVITE 902 and the serving application of the called user 104 may be the AS-B 503. The invitation message sent to the S-CSCF-B 502 of the called user 104 may be the INVITE 911. The serving application of the called user 104 validates the invitation with the profile of the called user 104. The called user's profile may indicate that the called user 104 has reverse charging active for all incoming calls, or depending on the caller, or due to other services being invoked. After the profile check if it is determined that the called user 104 has offline charging, then the serving application informs the charging function through an AVP in the IMS-Information about the particular party to be charged for particular media type. The attribute value pair (AVP) may be included in the accounting request. If it is determined that the called user 104 has online charging, then the serving application informs the charging function through an AVP in the IMS-Information, about the particular party to be charged for the particular media type. A user having online charging may be a prepaid user. For a prepaid user, the charging function may be the OCS 504. The AVP may be included in the credit request and for a user having online charging the credit request may be the CCR 903. The media-based charging information may be a part of the IMS-Information which may in turn be part of the Service-Information AVP in the CCR 903 message. If the called user 104 has online charging, the serving application sends the credit request to the OCS 504. The OCS 504 sends an acknowledgement back to the serving application. The acknowledgement may be a CCA 904. The invitation is then sent to the called user 104 through the S-CSCF-B 502 and the P-CSCF-B 505. The invitation sent to the S-CSCF-B 502 may be an INVITE 912, the invitation sent to the P-CSCF-B 505 may be an INVITE 913 and the invitation sent to the called user 104 may be an INVITE 914.

On receiving the invitation from the P-CSCF-B 505, the called user 104 sends a positive response to the serving application through the P-CSCF-B 505 and the S-CSCF-B 502. The response sent to the P-CSCF-B 505 may be a 200 OK 905 message, the response sent to the S-CSCF-B 502 may be a 200 OK 915 message and the response sent to the serving application may be a 200 OK 916 message. On receiving the response, the serving application includes the charging offer and the media and charging indicator in the response before sending it to the MGCF 501 through the S-CSCF-B 502. The media information indicates the media type for which the user would be charged and the charging indicator indicates which user to charge for the media type. The media type and the charging indicator may be included as a part of the SDP. The media type may be indicated by using an attribute ‘m’ in the SDP and the charging indicator may be included as an attribute ‘ci’ in the SDP. If the calling user 101 has to be charged for the call then ‘ci’ would be equal to caller and if the called user 104 has to be charged then ‘ci’ would be equal to called. If the called user 104 has offline charging then the serving application of the called user 104 may include the alternate charged party identification in the response. The response containing the charging offer is then sent to the MGCF 501 through the S-CSCF-B 502. The response sent by the serving application to the S-CSCF-B 502 may be a 200 OK 906 message and the response sent by the S-CSCF-B 502 to the MGCF 501 may be a 200 OK 917 message. The MGCF 501 interworks the response to a message containing the remote operations parameter, changes the charging indicator state to waiting for confirmation from the calling user 104, starts a timer and sends the message towards the PSTN/PLMN 103. The message sent towards the PSTN/PLMN may be the FAC 907 containing the remote operations parameter with the RevCalledRequest component, and with the transfer requested indication as ‘true’. The PSTN/PLMN 103 sends a response back to the MGCF 501 after indicating the transfer accepted field as true in the response. The response contains the remote operations parameter with the return response component. The response sent may be the FAC 908. On receiving the response at the MGCF 501, the MGCF 501 interworks the response to the charging answer and also mentions if the charging function is at the calling user 101 side or at the called user 104 side by indicating the mode as Transfer mode or No Transfer mode. The charging answer is included in an acknowledgement message. The timer that was started to wait for the response to the reverse charging request is stopped. The MGCF 501 then sends an answer message towards the PSTN/PLMN 103 and the acknowledgement towards the serving application through the S-CSCF-B 502. The answer message may be the ANM or CON 909 and the acknowledgement sent to the S-CSCF-B 502 may be the ACK 910. The acknowledgement sent to the serving application by the S-CSCF-B 502 may be the ACK 918. On receiving the acknowledgement, the serving application of the called user 104 accepts the answer if the called user 104 has offline charging or if the transfer accepted field is received as true. An acknowledgement is then sent to the called user 104 through the S-CSCF-B 502 and the P-CSCF-B 505 and the call then proceeds with the appropriate user being charged for the call. The acknowledgement sent to the S-CSCF-B 502 may be a ACK 919, the acknowledgement sent to the P-CSCF-B 505 may be a ACK 920 and the acknowledgement sent to the called user 104 may be a ACK 921. If the answer is not accepted then the scenario is handled as an exceptional scenario and the session may be terminated on receiving the charging answer.

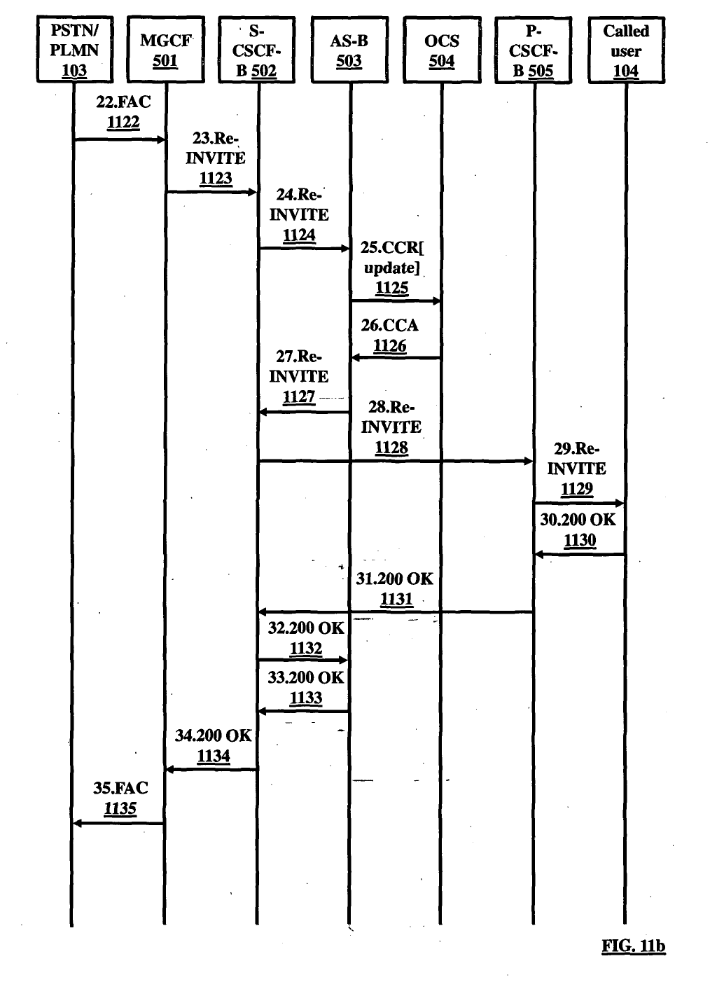

FIG. 10 is a diagram illustrating a call from a PSTN/PLMN 103 user to an IMS/SIP 102 user and the request for reverse charging is initiated in the response to the call request, in accordance with the embodiments herein. When the calling user 101 is a PSTN/PLMN 103 user and the called user 104 is an IMS/SIP 102 user the request for reverse charging may be initiated in the response to the call request. The initial message would be received by the MGCF 501 from the PSTN/PLMN 103. The initial message may be the JAM 1001. The MGCF 501 interworks the initial message to an invitation message and sends the invitation message to the serving application of the called user 104 through the S-CSCF-B 502. The invitation sent to the S-CSCF-B 502 may be a INVITE 1002 and the invitation sent to the serving application of the called user 104 may be a INVITE 1010. The serving application of the called user 104 forwards the invitation to the called user 104 through the S-CSCF-B 502 and the P-CSCF-B 505. The invitation sent to the S-CSCF-B 502 may be an INVITE 1011, the invitation sent to the P-CSCF-B 505 may be an INVITE 1012 and the invitation sent to the called user 104 may be an INVITE 1013. On receiving the invitation, the called user 104 sends a response to the invitation and includes the reverse charging request in the response. The media information and the charging indicator are included in the response. The media information indicates the media type for which the user would be charged and the charging indicator indicates which user to chaige for the media type. The media type and the charging indicator may be included as a part of the SDP. The media type may be indicated by using an attribute ‘m’ in the SDP and the charging indicator may be included as an attribute ‘ci’ in the SDP. If the calling user 101 has to be charged for the call then ‘ci’ would be equal to caller and if the called user 104 has to be charged then ‘ci’ would be equal to called. The called user 104 sends the response to the serving application of the called user 104 through the S-CSCF-B 502 and the P-CSCF-B 505. The response sent to the P-CSCF-B 505 may be a 200 OK 1003 message, the response sent to the S-CSCF-B 502 may be a 200 OK 1014 message and the response sent to the serving application may be a 200 OK 1015 message. On receiving the response the serving application of the called user 104 validates the response with the profile of the called user 104. If it is determined that the scenario is an exceptional scenario, an error response may be sent. After the profile check if it is determined that the called user 104 has offline charging, then the serving application may inform the charging function through an AVP in the IMS-Information about the particular party to be charged for the particular media type. The attribute value pair may be included in the accounting request sent towards the charging function. If it is determined that the called user 104 has online charging, then the serving application informs the charging function through an AVP in the IMS-Information about the particular party to be charged for particular media type. A user having online charging may be a prepaid user and for a user having online charging, the charging function may be the OCS 504. The AVP may be included in the credit request and for an online charged user the credit request may be the CCR 1004. The media related information may be a part of the IMS-Information which may in turn be part of the Service-Information AVP in the CCR 1004 message. The OCS 504 sends an acknowledgement back to the serving application. The acknowledgement may be a CCA 1005. On receiving the acknowledgement the serving application sends the response (received from the called user 104) to the S-CSCF-B 502. The response sent to the S-CSCF-B 502 may be a 200 OK 1016 message. On receiving the response the S-CSCF-B 502 sends the response to the MGCF 501. The response may be the 200 OK 1017 message.

The MGCF 501 interworks the response to a message containing the remote operations parameter, changes the charging indicator state to waiting for confirmation from the calling user 104, starts a timer and sends the message towards the PSTN/PLMN 103. The message sent towards the PSTN/PLMN may be the FAC 1006 containing the remote operations parameter with the RevCalledRequest component, and with the transfer requested indication as ‘true’. The PSTN/PLMN 103 sends a response back to the MGCF 501 after indicating the transfer accepted field as true in the response. The response contains the remote operations parameter with the return result component. The response sent may be the FAC 1007. On receiving the response at the MGCF 501, the MGCF 501 interworks the response to the charging answer and also mentions if the charging function is at the calling user 101 side or at the called user 104 side by indicating the mode as Transfer mode or No Transfer mode. The charging answer is included in an acknowledgement message. The timer that was started to wait for the response to the reverse charging request is stopped. The MGCF 501 then sends an answer message towards the PSTN/PLMN 103 and the acknowledgement towards the serving application through the S-CSCF-B 502. The answer message may be the ANM or CON 1008 and the acknowledgement sent to the S-CSCF-B 502 may be the ACK 1009. The acknowledgement sent by the S-CSCF-B 502 to the serving application may be the ACK 1018. On receiving the acknowledgement, the serving application of the called user 104 accepts the answer if the called user 104 has offline charging or if the transfer accepted field is received as true. An acknowledgement is sent to the called user 104 through the S-CSCF-B 502 and the P-CSCF-B 505 and the call then proceeds with the appropriate user being charged for the call. The response sent to the S-CSCF-B 502 may be a 200 OK 1019 message, the response sent to the P-CSCF-B 505 may be a 200 OK 1020 message and the response sent to the serving application may be a 200 OK 1021 message. If the answer is not accepted then the scenario is handled as an exceptional scenario and an error response may be sent. The various actions in the method may be performed in the order presented, in a different order, or simultaneously. Further, in some embodiments, some actions listed in FIG. 10 may be omitted.

FIGS. 11a and 11b are diagrams illustrating a reverse charged call from a PSTN/PLMN 103 user to an IMS/SIP 102 user and the calling user wants to revoke the reverse charging, in accordance with the embodiments herein. When the calling user 101 is a PSTN/PLMN 103 user and the called user 104 is an IMS/SIP 102 user and if reverse charging is active, the calling user may decide to revoke reverse charging later during the session. As an illustration, the reverse charging was requested by the called user 104 for the entire call, during the call setup. This is illustrated in Steps 1101 to 1121 in FIG. 11 which is quite similar to steps 901 to 921 in FIG. 9. FIG. 11 is a diagram illustrating a reverse charged call from a PSTN/PLMN 103 user to an IMS/SIP 102 user and the calling user wants to revoke the reverse charging, in accordance with the embodiments herein. When the calling user 101 is a PSTN/PLMN 103 user and the called user 104 is an IMS/SIP 102 user and if reverse charging is active, the calling user may decide to revoke reverse charging later during the session. As an illustration, the reverse charging was requested by the called user 104 for the entire call, during the call setup. This is illustrated in Steps 1101 to 1121 in FIG. 11 which is quite similar to steps 901 to 921 in FIG. 9. It is possible that other reverse charging was invoked in different other scenarios as discussed earlier—the only relevant aspect is that the call continues after the invocation of reverse charging.

After the call with reverse charging is active and the calling user 101 wants to revoke the reverse charging, then the calling user 101 sends a cancel component in the remote operations parameter to the called user 104. The cancel component may be RevCallingReqCancel component and the RevCallingReqCancel component may be included in the Remote Operations parameter within the FAC 1122. If the overall transfer mode indicates ‘transfer’ then the PSTN/PLMN 103 includes the calling number in the cancel component. The PSTN/PLMN 103 checks to see if reverse charging was already active. If reverse charging was not active an error response may be sent to the calling user. If reverse charging was active the cancel request is sent to the MGCF 501. The request sent may be the FAC 1122. The MGCF 501 interworks the cancel request to a re-invitation message with the media information and charging indicator included in the re-invitation message. The media information indicates the media type for which the user would be charged and the charging indicator indicates which user to charge for the specific media type. The media type and the charging indicator may be included as a part of the SDP. The media type may be indicated by using an attribute ‘m’ in the SDP and the charging indicator may be included as an attribute ‘ci’ in the SDP. If the calling user 101 has to be charged for the call then ‘ci’ would be equal to caller and if the called user 104 has to be charged then ‘ci’ would be equal to called. If the re-invitation message indicates overall transfer mode as ‘Transfer’ and the transfer requested field in the cancel component is true, then the MGCF 501 interworks the calling number to the charge information. The charge information may be the P-Charge-Info header. The MGCF 501 then changes the charging indicator state to waiting for response from the called user 104, starts a timer and then sends the re-invitation forward to the serving application through the S-CSCF-B 502. The re-invitation sent to the S-CSCF-B 502 may be the Re-INVITE 1123 and the serving application may be the AS-B 503. The re-invitation sent to the serving application may be the Re-INVITE 1124. The serving application of the called user 104 validates the re-invitation request with the profile of the called user 104. After the profile check if it is determined that the called user 104 has offline charging, then the serving application informs the charging function through an AVP in the IMS-Information, about the particular party to be charged for the particular media type. The AVP may be included in the accounting request sent towards the charging function. An AVP may be added in the accounting request to indicate that the calling user 101 is being charged. If it is determined that the called user 104 has online charging, then the serving application informs the charging function through an AVP in the IMS-Information, about the particular party to be charged for the particular media type. A user having online charging may be a prepaid user and for such a user the charging function may be the OCS 504. The AVP may be included in the credit request towards the charging function and for a user having online charging the credit request may be the CCR 1125. The media related information may be a part of the Service-Information AVP in the CCR 1125 message. If the called user 104 has online charging, the serving application sends the credit request to the OCS 504. The credit request may be in the form of CCR 1125. The OCS 504 sends an acknowledgement back to the serving application. The acknowledgement may be a CCA 1126. Note that when the reverse charging is revoked, the called user ceases to be the charged party. So the CCR [Update] may not be sent as illustrated in the figure, instead at the end of the session, CCR [Terminate] may instead be used to return any unused credit units. The re-invitation is then sent to the called user 104 through the S-CSCF-B 502 and the P-CSCF-B 505. The re-invitation sent to the S-CSCF-B 502 may be a Re-INVITE 1127, the re-invitation sent to the P-CSCF-B 505 may be a Re-INVITE 1128 and the re-invitation sent to the called user 104 may be a Re-INVITE 1129.

On receiving the re-invitation from the P-CSCF-B 505, the called user 104 can decide to accept or reject the offer. The terminal could consult the called user 104 or decide based on terminal settings whether to accept the offer or reject it before sending the response. If the request is rejected the scenario may be treated as an exceptional scenario and an error response is sent. If the called user 104 accepts the offer then the called user 104 sends a positive response to the serving application through the P-CSCF-B 505 and the S-CSCF-B 502. The response sent by the called user 104 to the P-CSCF-B 505 may be the 200 OK 1130 message. The response sent to the S-CSCF-B 502 may be the 200 OK 1131 message and the response sent to the serving application may be the 200 OK 1131 message. The serving application then sends the response with the charging answer indicating the acceptance of the request. The transfer accepted field may indicate if the mode was Transfer mode or No Transfer mode. If the overall mode is No Transfer mode and if the transfer accepted field is true then the serving application includes the identity of the reverse charged user in the charge information. The serving application then sends the response forward to the MGCF 501 through the S-CSCF-B 502. The response sent to the S-CSCF-B 502 may be the 200 OK 1133 message and the response sent to the MGCF 501 may be the 200 OK 1134 message. On receiving the response the MGCF 501 interworks the response to the message containing the return result component in the remote operations parameter and also includes the transfer accepted indication in the message. If the overall mode is ‘No Transfer’ and if the transfer accepted field is true then the called user 104 number is included in the charge information. The MGCF 501 then sends the response to the PSTN/PLMN 103 and stops the relevant timer. The timer was started to wait for the response to the reverse charging cancellation request. The response sent may be the FAC 1135. On receiving the response the call may proceed with the calling user 101 being charged for the call.

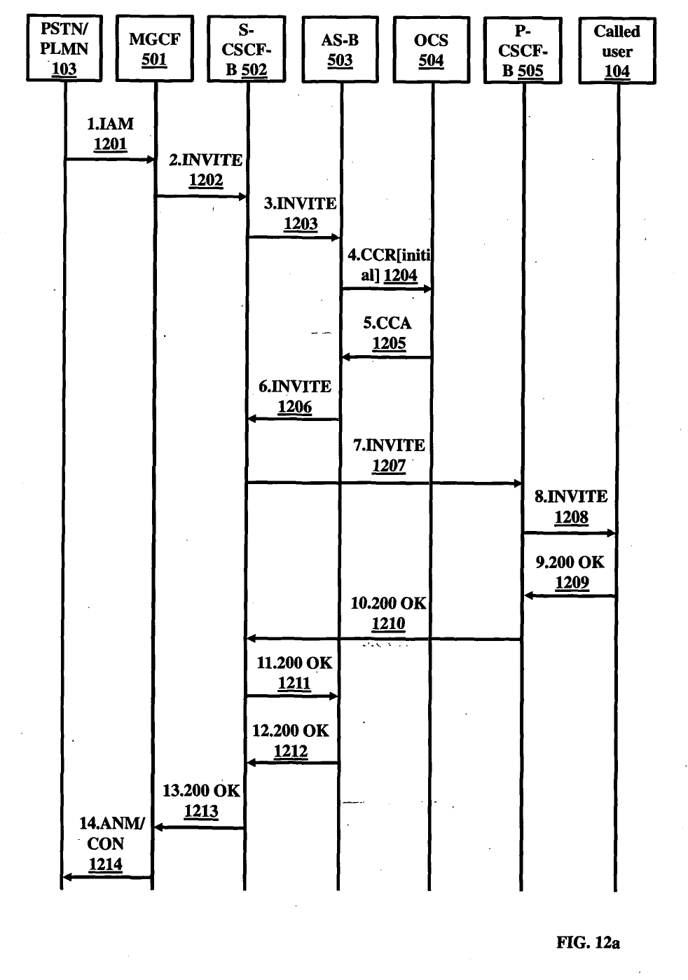

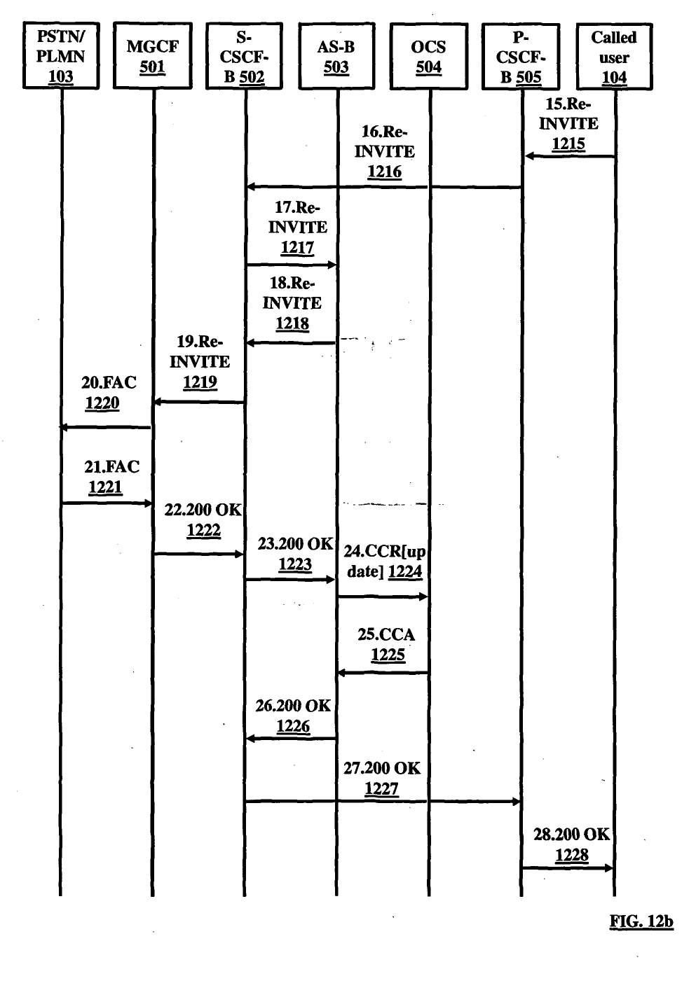

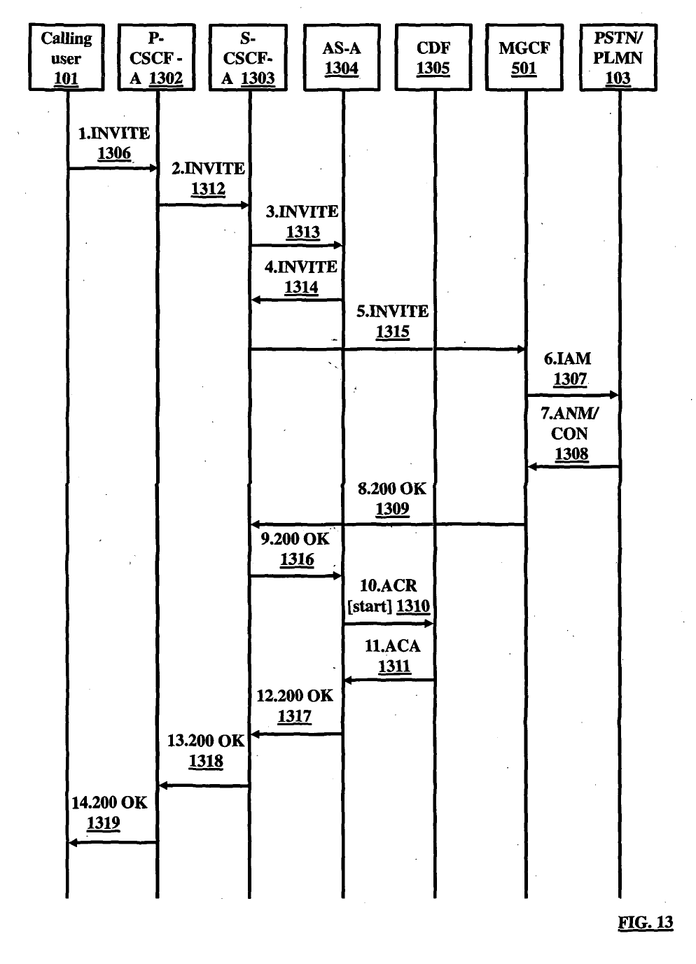

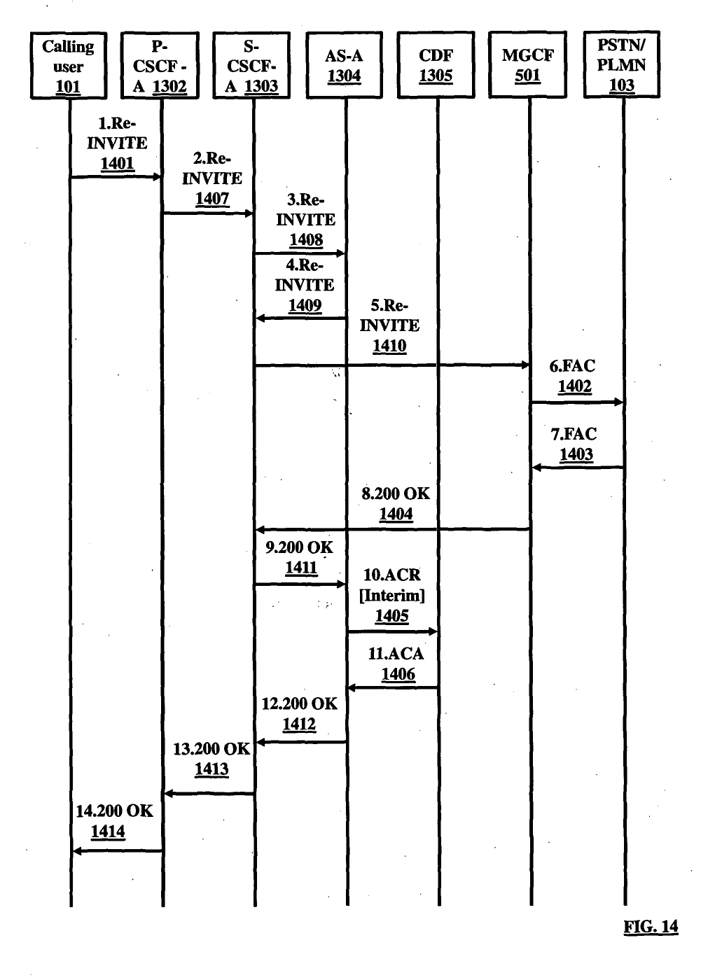

FIGS. 12a and 12b are diagrams illustrating a reverse charged call from a PSTN/PLMN 103 user to an IMS/SIP 102 user and the called user 104 wants to revoke the reverse charging, in accordance with the embodiments herein. When the calling user 101 is a PSTN/PLMN 103 user and the called user 104 is an IMS/SIP 102 user and if reverse charging is active, the called user may decide to revoke reverse charging later during the session. As an illustration, the reverse charging was requested by the calling user 104 for the entire call, during the call setup. This is illustrated in Steps 1201 to 1214 in FIG. 12 which is quite similar to steps 507 to 520 in FIG. 5. It is possible that other reverse charging was invoked in different other scenarios as discussed earlier—the only relevant aspect is that the call continues after the invocation of reverse charging.

After the call with reverse charging is active and the called user 104 wants to revoke the reverse charging then the called user 104 sends a cancel component in the remote operations parameter to the calling user 101. The cancel component may be the RevCalledReqCancel component in the Remote operations. The called user 104 sends a re-invitation message with the charging offer after including the media and charging indicator in the message. The media information indicates the media type for which the user would be charged and the charging indicator indicates which user to charge for the media type. The media type and the charging indicator may be included as a part of the SDP. The media type may be indicated by using an attribute ‘m’ in the SDP and the charging indicator may be included as an attribute ‘ci’ in the SDP. If the calling user 101 has to be charged for the call then ‘ci’ would be equal to caller and if the called user 104 has to be charged then ‘ci’ would be equal to called. The re-invitation is sent to the serving application of the called user 104 through the P-CSCF-B 505 and the S-CSCF-B 502. The re-invitation sent to the P-CSCF-B 505 may be the Re-INVITE 1215, the re-invitation sent to the S-CSCF-B 502 may be the Re-INVITE 1216 and re-invitation sent to the serving application may be the Re-INVITE 1217. The serving application of the called user 104 validates the invitation request with the profile of the called user 104. However, the charging function is informed only after successful acceptance of the reverse charging cancel request by the calling user. The serving application forwards the re-invitation to the MGCF 501 through the S-CSCF-B 502. The re-invitation sent to the S-CSCF-B 502 may be the Re-INVITE 1218 and re-invitation sent to the MGCF 501 may be the Re-INVITE 1219. The MGCF 501 interworks the re-invitation to a message containing the cancel component in the remote operations parameter. The message may be the FAC 1220. The MGCF 501 includes the transfer requested field in the message. If the overall mode indicates ‘No Transfer’ then the MGCF 501 includes the called number in the cancel component. The MGCF 501 then changes the charging indicator state to waiting for response from the calling user 104, starts a timer and then sends the message forward. The forwarded message may be received at the network of the calling user 101. If reverse charging was not active then an error response may be sent by the calling user's network 103. If reverse charging was active the calling user or the calling user's network can decide to accept or reject the offer. The calling user's terminal could consult the calling user 101 or decide based on terminal settings whether to accept the offer or reject it before sending the response. If the request is rejected the scenario may be treated as an exceptional scenario and an error response may be sent. If the calling user 101 accepts the offer then the calling user 101 may send a positive response.

On receiving a response from the calling user 101 the PSTN/PLMN 103 responds to the received message (from the MGCF 501) with a message containing the return result component in the remote operations parameter. If mode is ‘Transfer’ mode the transfer accepted field indicates true and if the mode is ‘No Transfer’ mode the transfer accepted field indicates false. If the overall transfer mode indicates ‘Transfer’ and if the transfer accepted field is true then the PSTN/PLMN 103 also includes the calling number in the return result component of the Remote Operations parameter. The PSTN/PLMN 103 then sends the message forward to the MGCF 501. The message sent may be the FAC 1221. If the message is a session release request then an error response may be sent and the session may be released. If the timer expires then an error response may be sent by the MGCF 501. On receiving the response, the MGCF 501 interworks the message to a response containing the SDP application body with the transfer accepted indication. If the overall mode indicates ‘Transfer’ and if the transfer accepted field is true then the MGCF 501 interworks the calling number in the return result component of the charge information in the response. The MGCF 501 then sends the response forward to the serving application of the called user 104 through the S-CSCF-B 502 and stops the relevant timer which was started to wait for the response to the reverse charging cancellation request. The response sent to the S-CSCF-B 502 may be the 200 OK 1222 and the response sent to the serving application may be the 200 OK 1223. After the profile check (done earlier on reception of the re-INVITE), if it is determined by the serving application 503 of the called user 104 that the called user 104 has offline charging, then, on reception of the response, the serving application informs the charging function through an AVP in the IMS-Information, about the particular party to be charged for the particular media type. The AVP may be included in the accounting request sent towards the charging function. An AVP may be added in the accounting request to indicate that the calling user 101 is being charged. If it is determined that the called user 104 has online charging, then the serving application informs the charging function through an AVP in the IMS-Information, about the particular party to be charged for the particular media type. A user having online charging may be a prepaid user and for such a user the charging function may be the OCS 504. The AVP may be included in the credit request towards the charging function and for a user having online charging the credit request may be the CCR 1224. The media related information may be a part of the IMS Information which may in turn be part of the Service-Information AVP in the CCR 1224 message. If the called user 104 has online charging, the serving application sends the credit request to the OCS 504. The credit request may be in the form of CCR 1224. The OCS 504 sends an acknowledgement back to the serving application. The acknowledgement may be a CCA 1225. Note that when the reverse charging is revoked, the called user ceases to be the charged party. So the CCR [Update] may not be sent as illustrated in the figure, instead at the end of the session, CCR [Terminate] may instead be used to return any unused credit units. The serving application sends the response forward to the called user 104 through the S-CSCF-B 502 and the P-CSCF-B 505 and the call may continue with the calling user being charged. The response sent to the S-CSCF-B 502 may be a 200 OK 1226 message, the response sent to the P-CSCF-B 505 may be a 200 OK 1227 message and the response sent to the called user 104 may be a 200 OK 1228 message. It is also possible that the revocation of the reverse charging request may be initiated by the called user's serving application 503, if the called user 104 is an online charged user, and the called user 104 has run out of credit units.

In other embodiments when the calling user 101 is a PSTN/PLMN 103 user and the called user 104 is an IMS/SIP 102 user, the charging information would have to be exchanged between users when the call is forwarded or diverted to user C. The call may be forwarded when the called user 104 returns a 302 response to the invitation message received from the calling user 101. The 302 message is a SIP response status code used to ask the calling user 101 to redirect the call. In this case the serving application of the called user 104 may still be involved in the session and the PSTN/PLMN may consider user C as the called party.

When the calling user 101 is a PSTN/PLMN 103 user and the called user 104 is an IMS/SIP 102 user and the calling user 101 requests the called user 104 for reverse charging at the start of the call, for a call which may be forwarded or diverted to user C. When the serving application of the called user 104 determines that the called user 104 has call diversion active in the profile of the called user 104, and invokes call diversion for the session, the serving application may not include any charging offer in the invitation that is sent towards user C, if the reverse charging request was received from the calling user 101 at the start of the session. The serving application of the called user 104 may also not send any charging answer. The MGCF 501 may then interwork the response to a release message containing the remote operations parameter with the return error component, and the Cause parameter having a cause value 29. The release message may be the REL and the return error component may indicate “Supplementary service interaction not allowed”. The MGCF 501 shall also clear the session in the forward direction by sending an appropriate message towards the S-CSCF 502. The serving application of the called user 104 may also choose to send a charging answer in the 200 OK response and indicate that the charging offer has been rejected. The MGCF 501 then interworks the response to a release message containing a remote operations parameter with the return error component, and the Cause parameter having a cause value 29. The release message may be the REL and the return error component may indicate “Supplementary service interaction not allowed”. The MGCF 501 shall also clear the session in the forward direction by sending an appropriate message towards the S-CSCF 502. The serving application of the called user 104 may also choose to send an error response with a reason header. The error response sent may be the SIP response code 418 Charging Indicator Not Acceptable with the reason header “Supplementary service interaction not allowed”. The MGCF then interworks the error response to a release message containing a remote operations parameter with the return error component. The return error component may indicate “Supplementary service interaction not allowed” and the Cause parameter may have a cause value 29. The MGCF 501 then releases the session in the backward direction. If the profile of the called user 104 indicates that reverse charging is applicable in the profile of the called user 104, and call diversion is active for the session, the serving application of the called user 104 may update the charging functions and send a charging answer indicating the acceptance of the charging offer. The serving application of the called user 104 sends the charging answer if the serving application is involved in the information exchange for the entire session and the profile of the called user 104 indicates that the reverse charging offer can be accepted automatically and all the checks done by the serving application are successful. The diverting network stores the charging offer internally and includes a new charging offer in the invitation sent to the network of user C, if appropriate information is present in the profile of the called user 104 and the serving application of the called user 104 is able to indicate that the call is a diverted call. The information in the profile of the called user 104 may include details required to initiate a charging offer. Diversion headers may be used to indicate that the call is a diverted call. When the serving application of user C determines that the call is a diverted call they serving application of user C triggers the charging functions. The serving application of user C indicates the charging indicator in the SDP application body as ‘called’ and sends a charging answer to the calling user 101. When the serving application of the called user 104 receives the charging answer, the serving application of the called user 104 updates the charging functions to indicate the charged party during the call. The serving application of the called user 104 then sends a charging answer to the calling user's 101 network based on the charging offer in the invitation.

When the calling user 101 is a PSTN/PLMN 103 user and the called user 104 is an IMS/SIP 102 user and the calling user 101 requests the called user 104 for reverse charging after the session is in progress, for a call that may have been forwarded or diverted to user C. When the serving application of the called user 104 determines that the called user 104 has call diversion active in the profile of the called user 104 and call diversion is active for the session, the serving application does not include any charging offer in the re-invitation that is sent towards user C. The serving application of the called user 104 may not send any charging answer. The MGCF 501 then interworks the response to an answer message containing the remote operations parameter with the return error component. The answer message may be the FAC and the return error component may indicate “Supplementary service interaction not allowed”. The serving application of the called user 104 may also choose to send a charging answer in the 200 OK response and indicate that the charging offer has been rejected. The MGCF 501 then interworks the response to an answer message containing a remote operations parameter with the return error component. The answer message may be the FAC and the return error component may indicate “Supplementary service interaction not allowed”. The serving application of the called user 104 may also choose to send an error response with a reason header. The error response sent may be the SIP response code 418 Charging Indicator Not Acceptable with the reason header “Supplementary service interaction not allowed”. The MGCF then interworks the error response to a release message containing a remote operations parameter with the return error component. The return error component may indicate “Supplementary service interaction not allowed” and the Cause parameter may have a cause value 29. The MGCF 501 may then release the session in the backward direction.

When the calling user 101 is a PSTN/PLMN 103 user and the called user 104 is an IMS/SIP 102 user and reverse charging is requested for the session then the serving application of the called user 104 may not invoke supplementary service interaction if the called user 104 has call diversion active in the profile of the called user 104 and call diversion has been activated for this session. Reverse charging may be handled by the network or the operator of the users. Priority to certain type of reverse charging may also be dependent on the network or the operator.

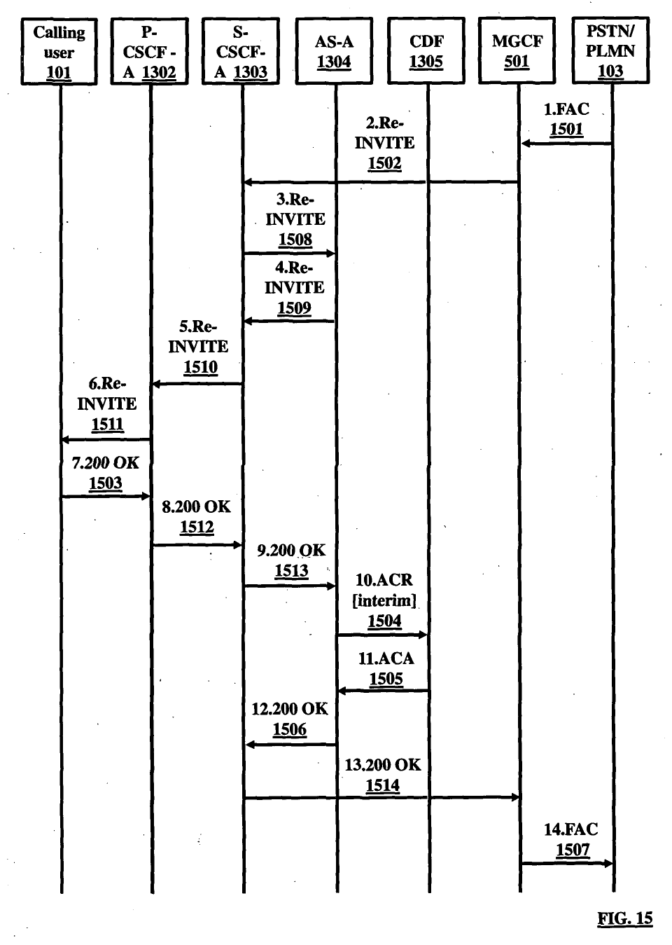

FIG. 13 is a diagram illustrating a reverse charging request from a calling IMS/SIP 102 user to a called PSTN/PLMN 103 user during the call setup, in accordance with the embodiments herein. When the calling user 101 is an IMS/SIP 102 user and the called user 104 is a PSTN/PLMN 103 user and if the calling user 101 or the network of the calling user 101 wants to request the called user 104 to become the charged party from the start of the call, the calling user 101 sends the request in the invitation message during the session setup phase. A request may also be sent if the calling user has subscribed for reverse charging for all sessions or for certain called users 104 or for certain networks connected to the called user 104. The request message sent may be the INVITE 1306 and the request message contains the charging offer. The media and charging indicator may be included in the invitation-message. The media information indicates the media type for which the user would be charged and the charging indicator indicates the user to be charged for the media type. The media type and the charging indicator may be included as a part of the SDP. The media type may be indicated by using the attribute ‘m’ in the SDP and the charging indicator may be included as the attribute ‘ci’ in the SDP. If the calling user 101 has to be charged for the call then ci would be equal to ‘caller’ and if the called user 104 has to be charged then ci would be equal to ‘called’. In the reverse charging request, ci would be set to “called”. The invitation may be sent forward to the MGCF 501 through the P-CSCF-A 1302, S-CSCF-A 1303 and the serving application of the calling user 101. The serving application of the calling user 101 may be an AS-A 1304. The invitation sent to the P-CSCF-A 1302 may be the INVITE 1306, the invitation sent to the S-CSCF-A 1303 may be the INVITE 1312 and the invitation sent to the serving application may be the INVITE 1313. The invitation sent from the serving application to the S-CSCF-A 1303 may be the INVITE 1314 and the invitation sent from the S-CSCF-A 1303 to the MGCF 501 may be the INVITE 1315. The MGCF 501 interworks the invitation to an initial message containing the remote operations parameter with the setup component and may include the transfer requested indication in the setup component. The initial message may be the IAM 1307 and the setup component may be the RevCallingReqSetup component in the Remote Operations parameter. If the transfer mode was requested then the MGCF 501 interworks the calling number in the setup component. The calling number may be mapped from the P-Charge-Info header or from the calling user related headers. The calling user related header may also be the P-Asserted-Id. The MGCF 501 then changes the charging indicator state to waiting for confirmation from the called user 104, starts a timer and then sends the initial message forward to the network of the called user 104.

If the network of the called user 104 allows reverse charging then the initial message is sent forward to the PSTN/PLMN 103 network by the MGCF 501. If the PSTN/PLMN 103 network of the called user 104 does not allow reverse charging then an error response may be sent by the MGCF 501. If the PSTN/PLMN 103 network allows the reverse charging request, then the request is sent forward to the called user 104. On receiving the reverse charging request, the called user 104 can decide to accept or reject the offer. The terminal could consult the called user 104 or decide based on terminal settings whether to accept the offer or reject it before sending the response. If the called user 104 accepts the offer then the called user 104 may send a positive response. The response contains the return result component in the remote operations parameter. The called user 104 may convey the positive response as an ISDN protocol element. The PSTN/PLMN 103 then sends the response of the called user to the MGCF 501. The response sent to the MGCF 501 may be the ANM/CON 1308. On receiving the response, the MGCF 501 checks to see if the timer has expired. If the timer has expired an error response may be sent. If the timer has not expired the MGCF 501 interworks the response to the response containing the charging answer included in the SDP application body. The transfer accepted field may be interworked to an indication within the SDP application body. If the mode indicated is ‘No Transfer’ mode, then the MGCF 501 indicates the transfer accepted field as false in the response and interworks the called number to the charge information. The charge information may be the P-Charge-Info header. The MGCF 501 then changes its state to indicate reverse charging is active, stops the relevant timer and sends the response towards the serving application of the calling user 101 through S-CSCF-A 1303. The serving application may be the AS-A 1304 and the response sent to the S-CSCF-A 1303 may be the 200 OK 1309. The response sent to the serving application may be a 200 OK 1316. The serving application of the calling user 101 validates the response with the profile of the calling user 101. After the profile check if it is determined that the calling user 101 has offline charging, then the serving application informs the charging function through an AVP in the IMS-Information, about the particular party to be charged for the particular media type. The AVP may be included in the accounting request 1310. An offline charged user may be a postpaid user and the charging function may be the CDF. A new grouped AVP type may be included in the IMS-Information in the accounting request sent towards the charging function. The new grouped AVP type may be a Media-B ased-Charging-Info AVP. If it is determined that the called user 104 has online charging, then the serving application may inform the charging function through an AVP in the IMS-Information, about the particular party to be charged for the particular media type. The attribute value pair may be included in the credit request and for a user having online charging the credit request may be the CCR 509. The media related information may be a part of the IMS-Information which in turn may be a part of the Service-Information AVP in the CCR 509 message. If the calling user 101 has offline charging the serving application sends the accounting request to the CDF 1305 and the accounting request may be in the form of ACR 1310. The CDF 1305 sends an acknowledgement back to the serving application. The acknowledgement may be the ACA 1311. The serving application then sends the response forward to the calling user 101 through the S-CSCF-A 1303 and the P-CSCF-A 1302. The response sent to the S-CSCF-A 1303 may be the 200 OK 1317, the response sent to the P-CSCF-A 1302 may be the 200 OK 1318 and the response sent to the calling user 101 may be the 200 OK 1319. The call may then proceed with the appropriate user being charged for the appropriate media type.

If the called user 104 could subscribe to the reverse charging feature then the network of the called user 104 may send the appropriate response to the request based on the profile settings of the called user 104. Instead of determining whether to accept the request based on the profile of the called user 104, the network of the called user 104 may also determine the willingness of the called user 104 to accept the reverse charging through interactive announcements. On getting a response from the called user 104 the response could be forwarded to the network of the calling user 101.

FIG. 14 is a diagram illustrating a reverse charging request from a calling IMS/SIP 102 user to a called PSTN/PLMN 103 user after the call is in progress, in accordance with the embodiments herein. When the call is in progress and the calling user 101 is an IMS/SIP 102 user and the called user 104 is a PSTN/PLMN 103 user and if the calling user 101 wants to request the called user 104 to become the charged party after the call is in progress, the calling user 101 sends the request after the session setup phase. The request message sent may be the Re-INVITE 1401. The media and charging indicator may be included in the re-invitation message. The media information indicates the media type for which the user would be charged and the charging indicator indicates the user to be charged for the media type. The media type and the charging indicator may be included as a part of the SDP. The media type may be indicated by using the attribute ‘m’ in the SDP and the charging indicator may be included as the attribute in the SDP. If the calling user 101 has to be charged for the call then ci would be equal to ‘caller’ and if the called user 104 has to be charged then ci would be equal to ‘called’. The re-invitation may also mention if the charging function is at the side of the calling user 101 or at the side of the called user 104 by indicating the mode as Transfer mode or No Transfer mode. The re-invitation is sent to the MGCF 501 through the P-CSCF-A 1302, S-CSCF-A 1303 and the AS-A 1304. The re-invitation sent to the P-CSCF-A 1302 may be the Re-INVITE 1401, the re-invitation sent to the S-CSCF-A 1303 may be a Re-INVITE 1407 and the re-invitation sent to the serving application may be the Re-INVITE 1408. The re-invitation sent from the serving application to the S-CSCF-A 1303 may be the Re-INVITE 1409 and the re-invitation sent from the S-CSCF-A 1303 to the MGCF 501 may be the Re-INVITE 1410. The MGCF 501 interworks the re-invitation to a message with the request component in the remote operations parameter. The request component may be the RevCallingReqActive component in the Remote operations parameter. If the re-invitation indicates ‘transfer requested’ then the MGCF 501 interworks this indication in the request component, and also includes the calling number to the request component. The calling number may be mapped from the P-Charge-Info header or from the calling user related headers. The MGCF 501 then changes the charging indicator state to waiting for confirmation from the called user 104, starts a timer and then sends the message forward to the network of the called user 104. The message sent may be the FAC 1402. If the network of the called user 104 allows reverse charging then the invitation is forwarded to the PSTN/PLMN 103 user. If the network of the called user 104 does not allow reverse charging then an error response may be sent.

On receiving the request from the PSTN/PLMN 103 network, the called user 104 can decide to accept or reject the offer. The terminal could consult the called user 104 or decide based on terminal settings whether to accept the offer or reject it before sending the response. If the called user 104 accepts the offer then the called user 104 sends a response to the PSTN/PLMN 103 network. The called user 104 may convey the positive response as an ISDN protocol element. The PSTN/PLMN 103 then sends the response to the MGCF 501. The response sent may be the FAC 1403. On receiving the response, the MGCF 501 checks to see if the timer has expired. If the timer has expired an error response may be sent. If the response was a session release request then an error response may be sent and the session may be released. If a positive response was received, the MGCF 501 interworks the return result included in the remote operations parameter to a response message. If the mode is indicated as No Transfer Mode then the transfer accepted field is indicated as false in the response message and the charge information is interworked in the return response. The charge information may be the P-Charge-Info header. The MGCF 501 then changes its state to indicate reverse charging is active, stops the timer and sends the response towards the serving application of the calling user 101 through the S-CSCF-A 1303. The response sent to the S-CSCF-A 1303 may be the 200 OK 1404 and response sent to the serving application may be the 200 OK 1411. On receiving the response at the serving application, the serving application validates the invitation request with the profile of the calling user 101. After the profile check if it is determined that the calling user 101 has offline charging, then the serving application informs the charging function through an AVP in the IMS-Information, about the particular party to be charged for the particular media type. The AVP may be included in the accounting request. An offline charged user may be a postpaid user and the charging function may be the CDF. The AVP may be included in an accounting request sent towards the charging function. The accounting request may be an ACR message. A new grouped AVP type may be included in the IMS-Information in the accounting request. The new grouped AVP type may be a Media-Based-Charging-Info AVP. If it is determined that the called user 104 has online charging, then the serving application may inform the charging function through an AVP in the IMS-Information, about the particular party to be charged for the particular media type. The attribute value pair may be included in the credit request and for an online charged user the credit request may be the CCR 509. The media related information may be a part of the IMS-Information which in turn may be part of the Service-Information AVP in the CCR 509 message. If the calling user 101 has offline charging the serving application sends the accounting request to the CDF 1305 and the accounting request may be in the form of ACR 1405. The CDF 1305 sends an acknowledgement back to the serving application. The acknowledgement may be an ACA 1406. The serving application then sends the response forward to the calling user 101 through the S-CSCF-A 1303 and the P-CSCF-A 1302. The response sent to the S-CSCF-A 1303 may be a 200 OK 1412 message, the response sent to the P-CSCF-A 1302 may be a 200 OK 1413 and the response sent to the calling user 101 may be a 200 OK 1414 message. After the calling user 101 receives the response the call may proceed with the appropriate party being charged for the call.

Instead of determining whether to accept the request based on the profile of the called user 104, the network of the called user 104 may determine the willingness of the called user 104 to accept the reverse charging through interactive announcements. On getting a response from the called user 104 the response could be forwarded to the network of the calling user 101.

FIG. 15 is a diagram illustrating a call from an IMS/SIP user to a PSTN/PLMN user and the called PSTN/PLMN user requests for reverse charging after the call is in progress, in accordance with the embodiments herein. When the call is in progress and the calling user 101 is an IMS/SIP 102 user and the called user 104 is a PSTN/PLMN 103 user and if the called user 104 wants to request the called user 104 (i.e., itself) to become the charged party after the call is in progress, the called user 104 sends the request after the session setup phase. The request sent may be the FAC 1501 and the request message includes the parameter with a setup component indicating that reverse charging is requested. The request message may be received by the MGCF 501. The MGCF 501 interworks the request message to a re-invitation message. The re-invitation message may be the Re-INVITE 1502. The MGCF 501 includes the media and charging indicator in the re-invitation message. The media type and the charging indicator may be included as a part of the SDP. The media type may be indicated by using an attribute ‘in’ in the SDP and the charging indicator may be included as an attribute ‘ci’ in the SDP. The re-invitation also mentions if the charging function is at the calling user 101's side or at the side of the called user 104 by indicating the mode as Transfer requested or not. If the setup component indicates No Transfer mode is requested, then the MGCF 501 maps the called number to the charge information. The MGCF 501 then changes the charging indicator state to waiting for confirmation from the calling user 104, starts a timer and then sends the re-invitation forward to the serving application of the calling user 101 through the S-CSCF-A 1303. The re-invitation sent to the S-CSCF-A 1303 may be the Re-INVITE 1502 and the re-invitation sent to the serving application may be a Re-INVITE 1508. The serving application of the calling user 101 may be the AS-A 1304. The serving application may then forward the re-invitation to the calling user 101 through the S-CSCF-A 1303 and the P-CSCF-A 1302.

On receiving the re-invitation, the calling user 101 can decide to accept or reject the offer. The terminal could consult the calling user 101 or decide based on terminal settings whether to accept the offer or reject it before sending the response. If the calling user 101 accepts the offer, then the calling user 101 sends a positive response to the serving application of the calling user 101 through the P-CSCF-A 1302 and the S-CSCF-A 1303. The response sent to the P-CSCF-A 1302 may be a 200 OK 1503, the response sent to the S-CSCF-A 1303 may be a 200 OK 1512 and the response sent to the serving application of the calling user 101 may be a 200 OK 1513. The response sent by the calling user 101 may contain information about the particular party to be charged for particular media type. The charged party and the media type information may be included in the SDP application body. On receiving the response at the serving application, the serving application validates the invitation request with the profile of the calling user 101. After the profile check if it is determined that the calling user 101 has offline charging, then the serving application informs the charging function through an AVP in the IMS-Information, about the particular party to be charged for the particular media type. The AVP may be included in the accounting request. An offline charged user may be a postpaid user and the charging function may be the CDF. The AVP may be included in an accounting request sent towards the charging function. The accounting request may be an ACR message. A new grouped AVP type may be included in the IMS-Information in the accounting request. The new grouped AVP type may be a Media-Based-Charging-Info AVP. If it is determined that the called user 104 has online charging, then the serving application may inform the charging function through an AVP in the IMS-Information, about the particular party to be charged for the particular media type. The attribute value pair may be included in the credit request and for an online charged user the credit request may be the CCR 509. The media related information may be a part of the IMS-Information which in turn may be part of the Service-Information AVP in the CCR 509 message. If the calling user 101 has offline charging the serving application sends the accounting request to the CDF 1305 and the accounting request may be in the form of ACR 1504. The CDF 1305 sends an acknowledgement back to the serving application. The acknowledgement may be an ACA 1505. The serving application sends the response forward to the MGCF 501 through the S-CSCF-A 1303. The response sent by the serving application to the S-CSCF-A 1303 may be a 200 OK 1506 message and the response sent by the S-CSCF-A 1303 to the MGCF 501 may be a 200 OK 1514. On receiving the response the MGCF 501 checks to see if the timer has expired. If the timer has expired an error response may be sent. If the response was a session release request then an error response may be sent and the session may be released. If a positive response was received, the MGCF 501 interworks the response to a message containing the remote operations parameter with the return result component. If the mode is indicated as Transfer Mode in the response, then the MGCF 501 indicates transfer accepted parameter as ‘true’ in the return response and includes the calling number in the return response. The MGCF 501 then changes its state to indicate reverse charging is active, stops the relevant timer and sends the response towards the called user 104. The response sent may be the FAC 1507. After the called user 104 receives the response the call may proceed with the appropriate party being charged for the call.

Instead of determining whether to accept the request based on the calling user's 101 profile, the network of the calling user 101 may determine the willingness of the calling user 101 to accept the reverse charging through interactive announcements. The interactive announcements may be made through a Media Server. On getting a response from the calling user 101 the response could be forwarded to the network of the called user 104.

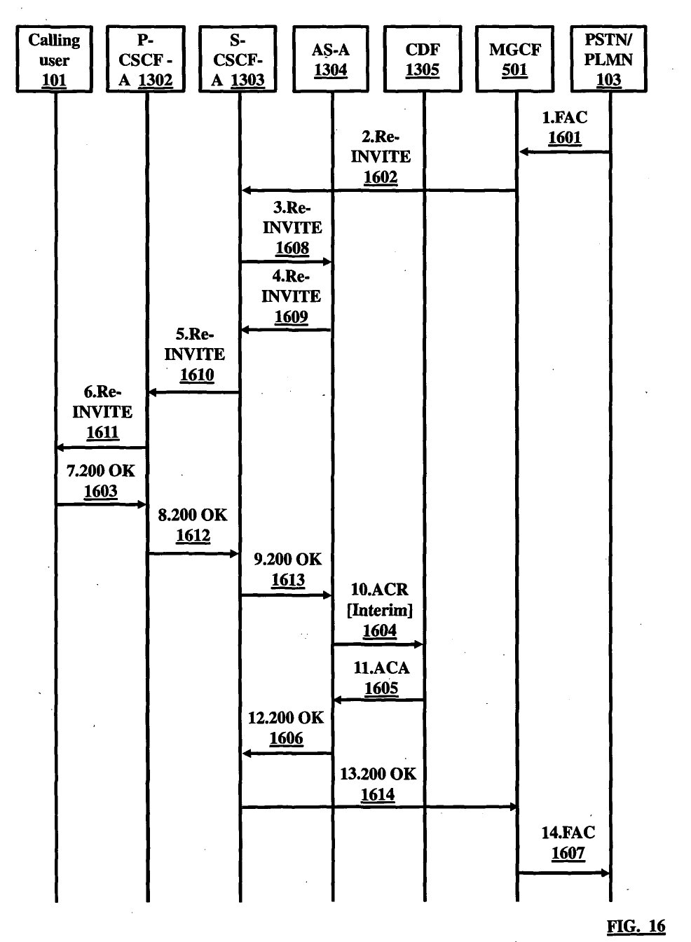

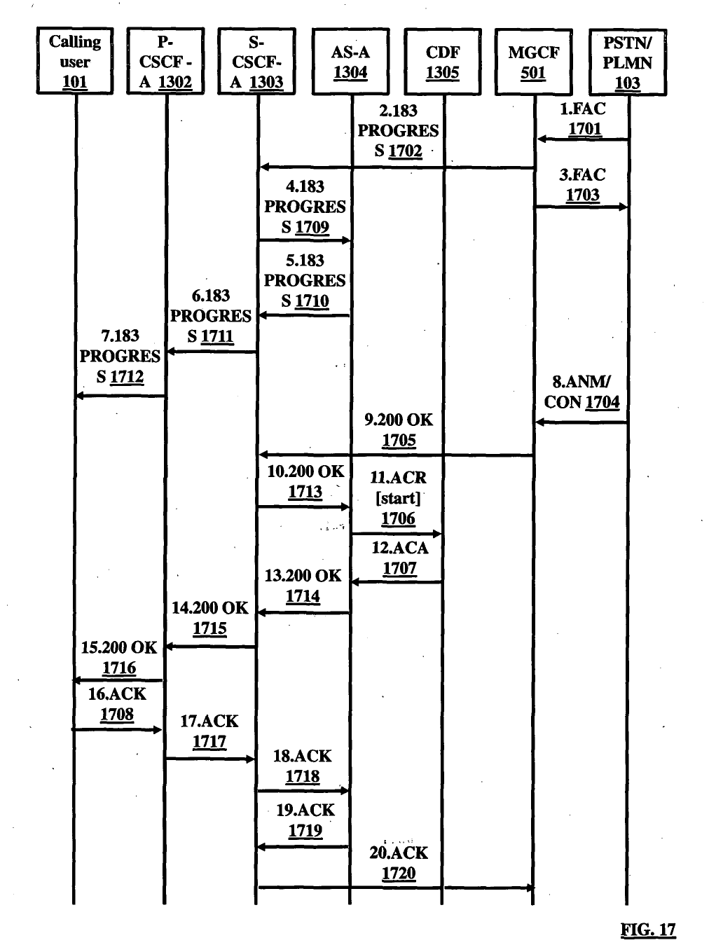

FIG. 16 is a diagram illustrating a call from an IMS/SIP user to a PSTN/PLMN user and the called PSTN/PLMN user requests for reverse charging after the session is in progress, in accordance with the embodiments herein. When the calling user 101 is an IMS/SIP 102 user and the called user 104 is a PSTN/PLMN 103 user and if the called user 104 wants to request the calling user 101 to become the charged party for the entire call after the call is in progress, the called user 104 sends the request after the session is established. The request message includes the parameter with a setup component indicating that reverse charging is requested. The request sent may be the FAC 1601 containing the RevCalledRequest component in the Remote Operations parameter. The request would not include an indication that the reverse charging request is only for the partial call, hence conveying the info that the reverse charging request is for the entirety of the session. The request would be received by the MGCF 501. The MGCF 501 interworks the request message to a re-invitation message. The re-invitation message may be the Re-INVITE 1602. The MGCF 501 includes the media and charging indicator in the re-invitation message. The media type and the charging indicator may be included as a part of the SDP. The media type may be indicated by using an attribute ‘m’ in the SDP and the charging indicator may be included as an attribute ‘ci’ in the SDP. If the request received by the MGCF indicates that the reverse charging request is for the entire session, then an attribute may be included in the SDP application body to indicate that the reverse charging is for the entire session. The re-invitation also mentions if the charging function is at the calling user 101 side or at the called user 104 side by indicating the mode as Transfer mode or No Transfer mode. If the setup component indicates No Transfer mode is requested, then the MGCF 501 maps the called number to the charge information. The MGCF 501 then changes the charging indicator state to waiting for confirmation from the calling user 104, starts a timer and then sends the re-invitation forward to the serving application of the calling user 101 through the S-CSCF-A 1303. The re-invitation sent to the S-CSCF-A 1303 may be a Re-INVITE 1602 and the re-invitation sent to the serving application may be a Re-INVITE 1608. The serving application of the calling user 101 may be the AS-A 1304. The serving application then forwards the re-invitation to the calling user 101 through the S-CSCF-A 1303 and the P-CSCF-A 1302. The re-invitation sent to the S-CSCF-A 1303 may be a Re-INVITE 1609, the re-invitation sent to the P-CSCF-A 1302 may be a Re-INVITE 1610 and the re-invitation sent to the calling user 101 may be the Re-INVITE 1611.

On receiving the re-invitation, the calling user 101 can decide to accept or reject the offer. The terminal could consult the calling user 101 or decide based on terminal settings whether to accept the offer or reject it before sending the response. If the calling user 101 accepts the offer, then the calling user 101 sends a positive response to the serving application of the calling user 101 through the P-CSCF-A 1302 and the S-CSCF-A 1303. The response sent to the P-CSCF-A 1302 may be a 200 OK 1603, the response sent to the S-CSCF-A 1303 may be a 200 OK 1612 and the response sent to the serving application may be a 200 OK 1613. The response may contain information about the particular party to be charged for particular media type. The charged party and the media type information may be included in the SDP application body. On receiving the response at the serving application the serving application includes a parameter to indicate the duration for which the reverse charging is active (in this case, the duration that has elapsed since the session was established). The serving application also validates the invitation request with the profile of the calling user 101. After the profile check if it is determined that the calling user 101 has online charging, then the serving application sends a message to the charging function requesting for a refund of the spent units. If it is determined that the calling user 101 has offline charging, then the serving application sends the media related accounting information in an accounting request. The accounting request may include the alternate charged party identity and an additional field indicating that the reverse charging is active for the entire session. The request may optionally include the duration for which the reverse charging is active. The request is then sent to the charging function and the charging function responds by sending an acknowledgement back to the serving application. The request sent may be the ACR 1604, the charging function may be the CDF 1305 and the acknowledgement send by the CDF 1305 may be the ACA 1605. The serving application then sends the response forward to the MGCF 501 through the S-CSCF-A 1303. The response sent to the S-CSCF-A 1303 may be a 200 OK 1606 and the response sent to the MGCF 50 may be a 200 OK 1614. On receiving the response, the MGCF 501 checks to see if the timer has expired. If the timer has expired an error response may be sent. If the response was a session release request then an error response may be sent and the session may be released. If a positive response was received, the MGCF 501 interworks the response to a message containing the return result component in the remote operations parameter. If the mode is indicated as Transfer Mode, then the MGCF 501 indicates transfer accepted parameter as ‘true’ in the return result component and also includes the calling number, as well as the duration for which reverse charging has been active (in this case, the duration that has elapsed since the session was established) in the return result component. The MGCF 501 then changes its state to indicate reverse charging is active, stops the timer and sends the response towards the called user 104. The message sent by the MGCF 501 towards the called user's PSTN/PLMN network 103 may be the FAC 1607. After the called user 104 receives the response the call may proceed with the appropriate party being charged for the call. Instead of determining whether to accept the request based on the profile of the calling user 101, the network of the calling user 101 may determine the calling user 101's willingness to accept the reverse charging through interactive announcements. The interactive announcements may be made through a Media Server. On getting a response from the calling user 101 the response could be forwarded to the network of the called user 104.

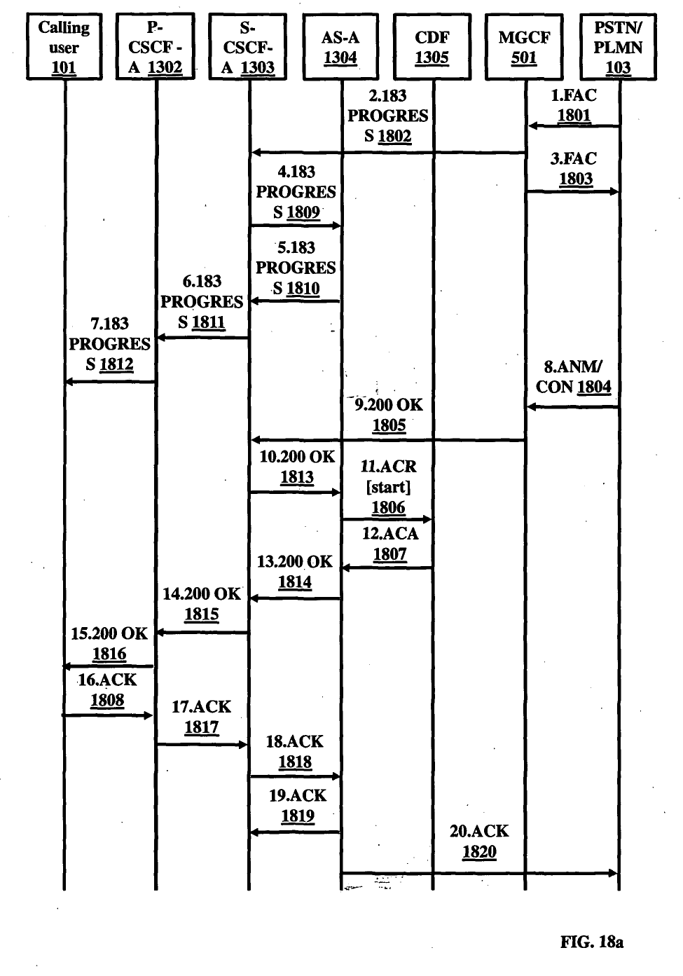

FIG. 17 is a diagram illustrating an IMS/SIP 102 user to a call from a PSTN/PLMN 103 user and reverse charging is requested for the call, in accordance with the embodiments herein. In this case the called user 104 may have subscribed for reverse charging for all incoming requests or for selective charging depending on the calling user 101 or depending on the services invoked. When the calling user 101 is an IMS/SIP 102 user and the called user 104 is a PSTN/PLMN 103 user and if reverse charging is requested then the request for reverse charging may be sent by the called user 104's network during the session setup phase. The request includes the parameter with a setup component indicating that reverse charging is requested. The setup component may be the RevCalledRequest invoke component in the Remote operations parameter and the request sent may be the FAC 1701. The FAC message 1701 is sent when the call is in wait answer state, i.e., the session is not yet established. The request may be received by the MGCF 501. The MGCF 501 sends a progress message with the SDP application body (interworked from the setup component received in the request message 1701) to the serving application of the calling user 101 through the S-CSCF-A 1303. The MGCF 501 includes the media and charging indicator in the progress message. The media information indicates the media type for which the user would be charged and the charging indicator would indicate which user to charge for the media type. The media type and the charging indicator may be included as a part of the SDP. The media type may be indicated by using an attribute ‘m’ in the SDP and the charging indicator may be included as an attribute ‘ci’ in the SDP. If the calling user 101 has to be charged for the call then ‘ci’ would be equal to caller and if the called user 104 has to be charged then ‘ci’ would be equal to called. The MGCF 501 also includes the transfer requested indication in the progress message. If the requested mode in the received request message is No Transfer mode, then the MGCF 501 maps the called number to the charge information in the progress message. The charge information may be the P-Charge-Info header. The MGCF 501 responds to the request message by sending a response message without waiting for the charging answer. If the mode indicated in the request message was transfer mode, then the MGCF 501 includes the calling number in the return result and indicates the transfer accepted field as true. The calling number may be mapped from the calling user related headers (received earlier in the invitation message). The serving application of the calling user 101 may be the AS-A 1304. The progress message sent to the S-CSCF-A 1303 may be the 183 Progress message 1702 and the progress message sent to the serving application may be the 183 Progress message 1709. The MGCF 501 also sends a response message as explained above containing the return result component within the remote operations parameter to the called user 104's PSTN/PLMN network 103. The message sent may be the FAC 1703. On receiving the progress message the serving application may either forward the offer to the calling user 101 or may accept the charging offer on its own. If the serving application accepts the charging offer then the acceptance information is stored in the serving application. If the calling user 101 has to give the charging answer, then the serving application forwards the charging offer to the calling user 101 through the S-CSCF-A 1303 and the P-CSCF-A 1302. The message sent to the S-CSCF-A 1303 may be the 183 Progress message 1710, the message sent to the S-CSCF-A 1303 may be a 183 Progress message 1711 and the message sent to the calling user 101 may be a 183 Progress message 1712. On receiving the charging offer the calling user 101 can decide to accept or reject the offer. The terminal could consult the calling user 101 or decide based on terminal settings whether to accept the offer or reject it before sending the response. If the calling user 101 does not accept the offer then an error response may be sent and the session may be released. If the calling user 101 accepts the offer then the calling user 101 sends a positive acknowledgement containing the charging answer. The charging answer is however not sent until the reception of a final response from the called user to the session setup request. After the FAC 1703 is received in the PSTN/PLMN 103, and the called user is informed, the called user 104 then sends the response to the session setup request to the MGCF 501 via the PSTN/PLMN 103. The response may be the ANM/CON 1704. The MGCF 501 then interworks the response to an appropriate message and sends it to the serving application of the calling user 101 through the S-CSCF-A 1303. The response sent to the S-CSCF-A 1303 may be the 200 OK 1705 and the response sent to the serving application of the calling user may be the 200 OK 1713. On receiving the response from the called user 104 the serving application checks the profile of the calling user 101. After the profile check if it is determined that the calling user 101 has offline charging, then the serving application informs the charging function through an AVP in the IMS-Information, about the particular party to be charged for the particular media type. The AVP may be included in the accounting request. An offline charged user may be a postpaid user and the charging function may be the CDF. The AVP may be included in an accounting request sent towards the charging function. A new grouped AVP type may be included in the IMS-Information in the accounting request. The new grouped AVP type may be a Media-Based-Charging-Info AVP. If it is determined that the calling user 104 has online charging, then the serving application informs the charging function through an AVP in the IMS-Information, about the particular party to be charged for the particular media type. The attribute value pair may be included in the credit request and for an online charged user the credit request may be the CCR 509. The media related information may be a part of the IMS-Information which in turn may be part of the Service-Information AVP in the CCR 509 message. If the calling user 101 has offline charging the serving application sends the accounting request to the CDF 1305 and the accounting request may be in the form of ACR 1706. The CDF 1305 sends an acknowledgement back to the serving application. The acknowledgement may be an ACA 1707. The serving application then sends the response to the calling user 101 through the S-CSCF-A 1303 and the P-CSCF-A 1302. The response sent to the S-CSCF-A 1303 may be a 200 OK 1714, the response sent to the P-CSCF-A 1302 may be a 200 OK 1715 and the response sent to the calling user 101 may be a 200 OK 1716. On receiving the response the calling user 101 replies by sending a charging answer in the acknowledgement to the MGCF 501 through the P-CSCF-A 1302, S-CSCF-A 1303 and the serving application of the calling user 101. The acknowledgement sent to the P-CSCF-A 1302 may be a 200 OK 1708, the acknowledgement sent to the S-CSCF-A 1303 may be a 200 OK 1717 and the acknowledgement sent to the serving application may be a 200 OK 1718. The acknowledgement sent from the serving application to the S-CSCF-A 1303 may be a 200 OK 1719 and the acknowledgement sent from the S-CSCF-A 1303 to the MGCF 501 may be a 200 OK 1720. The acknowledgement sent may be the ACK message. The call may then proceed with the appropriate party being charged for the call.

If the initial session request message sent from the calling IMS/SIP network to the MGCF contains an SDP offer, and the called PSTN/PLMN network 103 sent already an ACM, which was interworked by the MGCF to an SDP answer in a 18× response, then on reception of the FAC 1701 message subsequently, containing the RevCalledRequest component in the Remote Operations parameter, the MGCF 501 may interwork it to the UPDATE message containing the charging offer with the charging indicator set to the appropriate value. This UPDATE message may be sent to the calling user 101 via the S-CSCF-A 1303, serving application of the calling user 1304, again the S-CSCF-A 1303 and then the P-CSCF-A 1302. The calling user 101 may then decide to accept the charging offer by sending a 200 OK response to the UPDATE message. This 200 OK is sent to the MGCF 501 via the P-CSCF-A 1302, S-CSCF-A 1303, serving application of the calling user 1304, and again through the S-CSCF-A 1303. The MGCF then interworks the 200 OK response to the UPDATE message to the FAC message 1703 and send it to the called PSTN/PLMN network 103. The serving application of the calling user 1304 may inform the charging functions on reception of the 200 OK response to the UPDATE message from the calling user (via the P-CSCF-A 1302 and S-CSCF-A 1303).

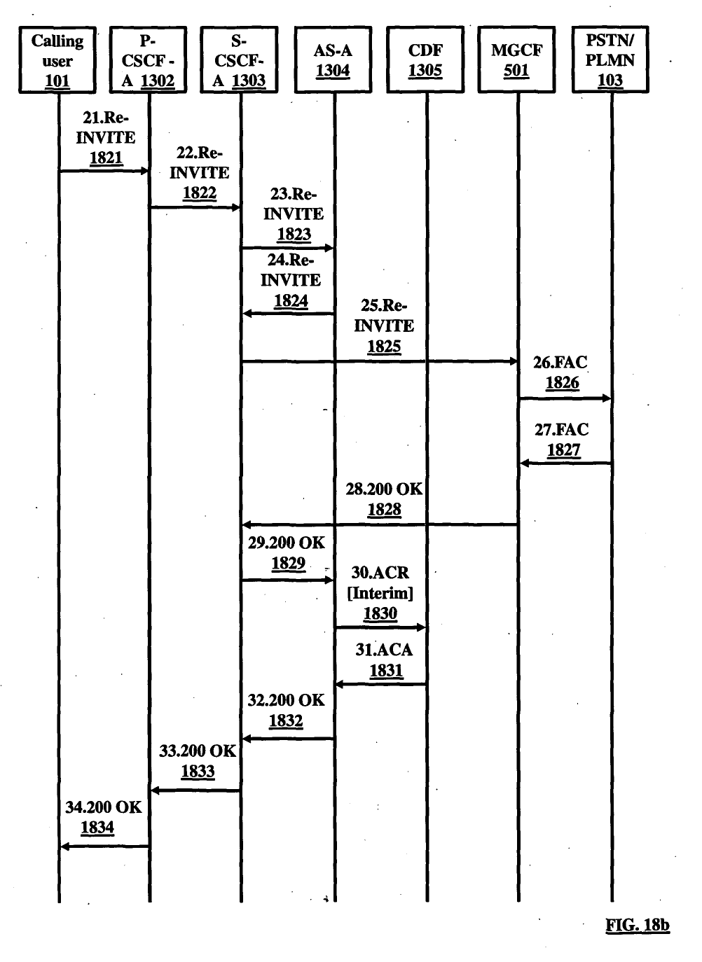

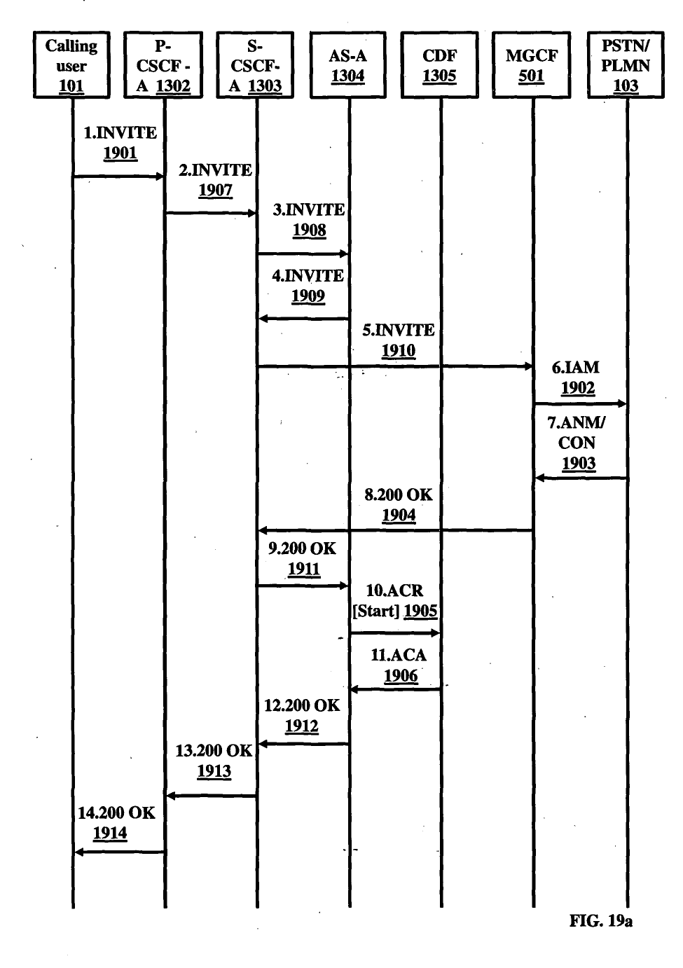

FIGS. 18a and 18b are diagrams illustrating a reverse charged call from an IMS/SIP user to a PSTN/PLMN user and the calling user wants to revoke the reverse charging, in accordance with the embodiments herein. When the calling user 101 is a IMS/SIP 102 user and the called user 104 is an PSTN/PLMN 103 user and if reverse charging is active, the calling user may decide to revoke reverse charging later during the session. As an illustration, the called user 101 may have subscribed for reverse charging for all incoming requests or for selective charging depending on the calling user 101 or depending on the services invoked. The reverse charging request is made from the called user/called network side during the session setup phase. This is illustrated in steps 1801-1820 of FIG. 18, which is quite similar to steps 1701-1720 of FIG. 17. These steps illustrate the successful activation of reverse charging from the start of the session itself. The call may then proceed with the appropriate party being charged for the call. It is possible that other reverse charging was invoked in different other scenarios as discussed earlier—the only relevant aspect is that the call continues after the invocation of reverse charging.

After the call with reverse charging is active and the calling user 101 wants to revoke the reverse charging then the calling user 101 sends a reverse charging cancel request to the called user 104. The cancel request may be sent in the form of a Re-INVITE 1821. The calling user 101 sends the re-invitation message with the media and charging indicator included in the re-invitation. Re-INVITE 1821. The media information indicates the media type for which the user would be charged and the charging indicator would indicate which user to charge for the media type. The media type and the charging indicator may be included as a part of the SDP. The media type may be indicated by using an attribute ‘m’ in the SDP and the charging indicator may be included as an attribute ‘ci’ in the SDP. The re-invitation is sent to the serving application of the calling user 101 through the P-CSCF-A 1302 and the S-CSCF-A 1303. The re-invitation sent to the P-CSCF-A 1302 may be the Re-INVITE 1821, the re-invitation sent to the S-CSCF-A 1303 may be a Re-INVITE 1822 and the re-invitation sent to the serving application may be the Re-INVITE 1823. The serving application then forwards the re-invitation to the MGCF 501 through the S-CSCF-A 1303. The re-invitation sent to the S-CSCF-A 1303 may be the Re-INVITE 1824 and the re-invitation sent to the MGCF 501 may be a Re-INVITE 1825. The MGCF 501 interworks the re-invitation to a message containing the cancel component in the remote operations parameter. The cancel component may be the RevCallingReqCancel component in the Remote operations parameter. FAC 1826. The MGCF 501 includes the transfer requested field in the message indicating that the charging function is to be performed by the calling user 101's network. The MGCF 501 then changes the charging indicator state to waiting for response from the called user 104, starts a timer and then sends the message forward. The message sent may be the FAC 1826. The FAC message may be received at the network of the called user 104. If reverse charging was not active then an error response may be sent. If reverse charging was active, the called user 104 can decide to accept or reject the offer. The terminal could consult the called user 104 or decide based on terminal settings whether to accept the offer or reject it before sending the response. If the request is rejected the scenario may be treated as an exceptional scenario and an error response may be sent. If the called user 104 accepts the offer then the called user 104 sends a positive response to the called user's PSTN/PLMN network 103. The called user's PSTN/PLMN 103 then sends a positive response to the MGCF 501. The response sent may be the FAC 1827.

On receiving the response, the MGCF 501 checks to determine if the response was a session release request. If the response was a session release request then an error response may be sent and the session may be released. If the timer expires then an error response may be sent by the MGCF 501. On receiving a positive response, the MGCF 501 interworks the response to the message containing the SDP body with the transfer accepted indication. If the overall mode indicates No Transfer and if the transfer accepted field is indicated as true, then the MGCF 501 interworks the called number in the return result component of the charge information. The charge information may be the P-Charge-Info header. The MGCF 501 then sends the response forward to the serving application of the calling user 101 through the S-CSCF-A 1303 and stops the relevant timer. The response sent to the S-CSCF-A 1303 may be a 200 OK 1828 and the response sent to the serving application may be a 200 OK 1829. On receiving the response from the called user 104, the serving application validates the response with the profile of the calling user 101. After the profile check if it is determined that the calling user 101 has offline charging, then the serving application informs the charging function through an AVP in the IMS-Information, about the particular party to be charged for the particular media type. The AVP may be included in the accounting request and the charging function may be the CDF. If it is determined that the called user 104 has online charging, then the serving application informs the charging function through an AVP in the IMS-Information, about the particular party to be charged for the particular media type. The attribute value pair may be included in the credit request and for an online charged user the credit request may be the CCR 509. If the calling user 101 has online charging and if the overall mode indicates ‘Transfer’ then the session is released by the serving application of the calling user 101. If the calling user 101 has offline charging the serving application sends the accounting request to the CDF 1305 and the accounting request may be in the form of ACR 1830. The CDF 1305 sends an acknowledgement back to the serving application. The acknowledgement may be an ACA 1831. The serving application then sends the response forward to the calling user 101 through the S-CSCF-A 1303 and the P-CSCF-A 1302. The response sent to the S-CSCF-A 1303 may be a 200 OK 1832, the response sent to the P-CSCF-A 1302 may be a 200 OK 1833 and the response sent to the calling user 101 may be a 200 OK 1834. The call may then continue with the calling user being charged for the call.

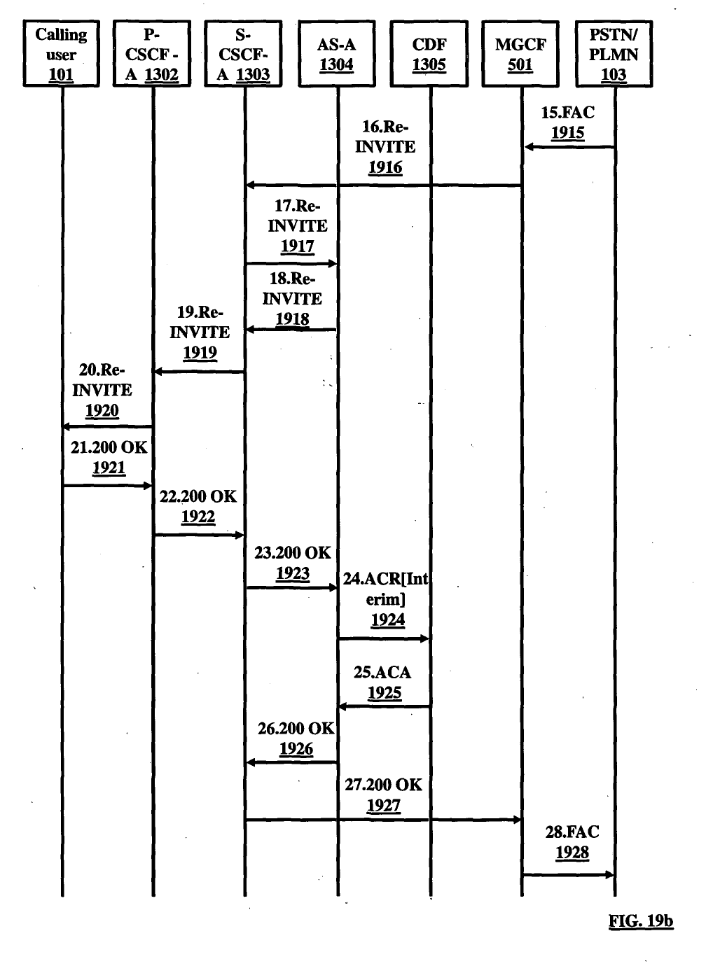

FIGS. 19a and 19b are diagrams illustrating a reverse charged call from an IMS/SIP user to a PSTN/PLMN user and the called user wants to revoke the reverse charging, in accordance with the embodiments herein. When the calling user 101 is a IMS/SIP 102 user and the called user 104 is an PSTN/PLMN 103 user and if reverse charging is active, the called user may decide to revoke reverse, charging later during the session. As an illustration, the reverse charging was requested by the calling user 104 for the entire call, during the call setup. This is illustrated in Steps 1901 to 1914 in FIG. 19 which is quite similar to steps 1306 to 1319 in FIG. 13. It is possible that other reverse Charging was invoked in different other scenarios as discussed earlier—the only relevant aspect is that the call continues after the invocation of reverse charging.

After the call with reverse charging is active and the called user 104 wants to revoke the reverse charging then the called user 104 sends a cancel request to the calling user 101. The cancel request is sent along with a cancel component in the remote operations parameter to the MGCF 501 by the called PSTN/PLMN 103. The cancel component may be the RevCalledReqCancel component in the remote operations parameter. The PSTN/PLMN 103 checks to see if reverse charging was already active. If reverse charging was not active an error response may be sent to the called user 104. If reverse charging was active then the cancel request is sent to the MGCF 501. The cancel request may be sent as the FAC 1915. On receiving the cancel request the MGCF 501 interworks the cancel request to a re-invitation message with the media and charging indicator included. The re-invitation message may be the Re-INVITE 1916 and the media type and the charging indicator may be included as a part of the SDP. The media type may be indicated by using an attribute ‘m’ in the SDP and the charging indicator may be included as an attribute ‘ci’ in the SDP. The MGCF 501 maps the transfer requested indication in the cancel component to an indication in the SDP application body. If the cancel request indicates overall transfer mode as No Transfer and the transfer requested field is indicated as true in the cancel component, then the MGCF 501 interworks the called number to the charge information. The charge information may be the P-Charge-Info header. The MGCF 501 then changes the charging indicator state to waiting for response from the calling user 101, starts a timer and then sends the re-invitation to the serving application of the calling user 101 through the S-CSCF-A 1303. The re-invitation sent to the S-CSCF-A 1303 may be the Re-INVITE 1916 and the re-invitation sent to the serving application may be a Re-INVITE 1917. The serving application then sends the re-invitation to the calling user 101 through the S-CSCF-A 1303 and the P-CSCF-A 1302. The re-invitation sent to the S-CSCF-A 1303 may be the Re-INVITE 1918, the re-invitation sent to the P-CSCF-A 1302 may be a Re-INVITE 1919 and the re-invitation sent to the calling user 101 may be the Re-INVITE 1920. If the overall transfer mode is Transfer and if the calling user 101 has online charging and if transfer requested was true in the re-INVITE, then the serving application of the calling user 1304 may send an error response to the re-invitation message to the MGCF 501.

On receiving the re-invitation from the serving application the calling user 101 can decide to accept or reject the offer. The terminal could consult the calling user 101 or decide based on terminal settings whether to accept the offer or reject it before sending the response. If the request is rejected the scenario may be treated as an exceptional scenario and an error response may be sent. If the calling user 101 accepts the offer then the calling user 101 may send a positive response with the charging answer indicating the acceptance of the request to the serving application of the calling user 101 through the P-CSCF-A 1302 and the S-CSCF-A 1303. The response sent to the P-CSCF-A 1302 may be a 200 OK 1921, the response sent to the S-CSCF-A 1303 may be a 200 OK 1922 and the response sent to the serving application may be a 200 OK 1923. The serving application of the calling user 101 validates the re-invitation request with the profile of the calling user 101. After the profile check if it is determined that the calling user 101 has offline charging, then the serving application informs the charging function through an AVP in the IMS-Information, about the particular party to be charged for the particular media type; The new grouped AVP type may be a Media-Based-Charging-Info AVP. If it is determined that the called user 104 has online charging, then the serving application may inform the charging function through an AVP in the IMS-Information, about the particular party to be charged for the particular media type. The attribute value pair may be included in the credit request and for an online charged user the credit request may be the CCR 509. The media related information may be a part of the IMS-Information which in turn may be part of the Service-Information AVP in the CCR 509 message. If the calling user 101 has offline charging the serving application sends the accounting request to the CDF 1305 and the accounting request may be in the form of ACR 1924. The CDF 1305 sends an acknowledgement back to the serving application. The acknowledgement may be an ACA 1925. On receiving the acknowledgement the serving application sends the response forward to the MGCF 501 through the S-CSCF-A 1303. The response sent to the S-CSCF-A 1303 may be a 200 OK 1926 the response sent to the MGCF 501 may be a 200 OK 1927. The transfer accepted field in the response may indicate if the mode was Transfer mode or No Transfer mode.

On receiving the response the MGCF 501 checks to determine if the response was a session release request. On receiving a session release request an error response may be sent and the session may be released. If the timer has expired an error response may be sent. If a positive response was received by the MGCF 501, the MGCF 501 interworks the response to the message containing the return result component in the remote operations parameter and also includes the transfer accepted indication in the return result. The message may be the FAC 1928. If the overall mode is Transfer mode and if the transfer accepted field is indicated as true then the calling user number is included in the return result component. The MGCF 501 then sends the response to the PSTN/PLMN 103 and stops the relevant timer. On receiving the response by the called PSTN/PLMN 103 the call may proceed with the calling user being charged for the call.

If the calling user 101 could subscribe to the request then the serving application of the calling user 101 may send the appropriate response to the request based on the profile settings of the calling user 101. Instead of determining whether to accept the request based on the profile of the calling user 101, the serving application may also determine the calling user 101's willingness to accept the reverse charging through interactive announcements. On getting a response from the calling user 101 the response will be forwarded to the network of the called user 104.

In other embodiments when the calling user 101 is an IMS/SIP 102 user and the called user 104 is a PSTN/PLMN 103 user, the charging information may have to be exchanged between users when the call is forwarded or diverted to user C. The call may be forwarded when the called user 104 returns a ‘302 response’ to the invitation message received from the calling user 101. The 302 message is a SIP response code used to ask the calling user 101 to redirect the call. In this case the serving application of the called user 104 may still be involved in the session and the PSTN/PLMN may consider user C as the called party. Reverse charging may be handled by the network or the operator of the users. Priority to certain type of reverse charging may also be dependent on the network or the operator.

When the calling user 101 is a PSTN/PLMN 103 user and the called user 104 is an IMS/SIP 102 user and the calling user 101 requests the called user 104 for reverse charging at the start of the call for a call which may be forwarded or diverted to user C. When it is determined that the called user 104 has call diversion active in the profile of the called user 104 and call diversion is active for the session, the PSTN/PLMN 103 may send a release message containing the remote operations parameter with the return error component indicating “Supplementary service interaction not allowed”. The MGCF 501 then interworks the response to a charging answer message in the 200 OK response indicating that the charging offer has been rejected, and subsequently initiate the session release in both directions. If the profile of the called user 104 indicates that reverse charging is applicable for this session request, then the charging offer may be accepted by the PSTN/PLMN 103 of the called user 104 and the PSTN/PLMN 103 sends the appropriate response to the calling user 101. The PSTN/PLMN 103 of the called user 104 makes the necessary updates in the response received from user C's network to indicate the acceptance of the charging offer before sending the response to the network of the calling user 101.

When the calling user 101 is a PSTN/PLMN 103 user and the called user 104 is an IMS/SIP 102 user and the calling user 101 requests for reverse charging after the session is in progress, for a call which has been forwarded or diverted to user C. When it is determined that the called user 104 has call diversion active in the profile of the called user 104 and call diversion is active for the session, the PSTN/PLMN 103 sends a FAC message containing the remote operations parameter with the return error component indicating “Supplementary service interaction not allowed”. The return error component is interworked by the MGCF 501 to an error response with a reason header. The error response sent may be the SIP response code 418 Charging Indicator Not Acceptable with the reason header “Not Available”.

There may be timers used in the network of the calling user 101 or the network of the called user 104 used to wait for response from the appropriate party. If the calling user 101 wants to request the called user 104 to become the charged party from the start of the call the MGCF 501 starts a timer to wait for the RevCallingReqSetup response. If the calling user 101 wants to request the called user 104 to become the charged party after the session is active, the MGCF 501 starts a timer to wait for the RevCallingReqActive response. If the called user 104 wants to request the calling user 101 to become the charged party after the session is active, the MGCF 501 starts a timer to wait for the RevCalledRequest response. If the called user 104 wants to request the calling user 101 to become the charged party from the start of the session, the MGCF 501 starts a timer to wait for the RevCalledRequest response. If the calling user 101 wants to revoke the reverse charging that is active, the MGCF 501 starts a timer to wait for the RevCallingReqCancel response. If the called user 104 wants to revoke the reverse charging that is active, the MGCF 501 starts a timer to wait for the RevCalledReqCancel response.

In other embodiments if the serving application is not the AS-A 1304 then the S-CSCF-A 1303 may also perform the functions performed by the AS-A 1304. The interface between the S-CSCF-A 1303 and the OCS 504 would be through the IMS-GWF. The S-CSCF-A 1303 of the calling user 101 may either activate the AS-A 1304 of the calling user 101 or perform all the actions done by the serving application. If the serving application is not the AS-B 503 then the S-CSCF-B 502 may also perform the functions performed by the AS-B 503. The interface between the S-CSCF-B 502 and the OCS 504 would be through the IMS-Gateway function (GWF). The S-CSCF-B 502 of the called user 104 may either activate the AS-B 503 of the called user 104 or perform all the actions done by the serving application. In case of SIP networks, the actions performed by the serving application may also be performed by the SIP Proxy server. The functions of the gateway may be performed by the MGCF 501 or by the PSTN/PLMN 103 gateway network element. The charging functions may or may not be co-located within the SIP Proxy, and the interface to the charging functions may be network/operator dependent. The network controller may also perform the functions of the MGCF 501 and the PSTN/PLMN 103.

In other embodiments, when reverse charging is requested by the called user, then the calling user's network may decide to accept or reject the request without consulting the calling user. A notification of the reverse charging request may optionally be sent to the calling user. When reverse charging is revoked by the calling user, the called user's network may decide to accept or reject the request without consulting the called user. A notification of the reverse charging revocation request may optionally be sent to the called user.

In other embodiments, it is possible that the revocation of reverse charging may be for the entire session, and an additional indication may be included in the reverse charging revocation request. The charging functions are then informed accordingly, so that the calling user is then charged for the entirety of the session. In other embodiments end-to-end signaling methods may be used by the PSTN/PLMN 103 to interwork reverse charging information between PSTN/PLMN 103 networks. The end-to-end methods used may be the Pass Along Method or Signaling Connection Control Part (SCCP). SCCP is a network layer protocol that provides extended routing, flow control, segmentation, connection-orientation, and error correction facilities in Signaling System 7 telecommunications networks. Pass Along Method is a signaling scheme wherein the information is sent along the signaling path of a previously established physical connection. When end-to-end signaling methods are used the MGCF 501 may interwork the end-to-end signaling contents to an appropriate charging offer and charging answer.

If the IMS/SIP 102 network initiates a charging offer and a charging answer indicating reverse charging is only for some media and not for the whole session, the MGCF 501 may allow the successful completion of such calls. If the media based charging is requested in a charging offer from the IMS/SIP 102 network then the MGCF 501 converts the charging offer into the appropriate reverse charging request and sends the request towards the PSTN/PLMN 103. If the PSTN/PLMN 103 accepts the request then the MGCF 501 sends the charging answer indicating reverse charging is for all the media types involved in the session. If the media based charging is requested in a charging answer from the IMS/SIP 102 network, then the MGCF 501 indicates that media based charging is not allowed. An additional attribute may be used within the SDP application body to indicate that media based charging is not allowed. The MGCF 501 converts the charging answer into the appropriate reverse charging response and sends the response towards the PSTN/PLMN 103. The MGCF then initiates a new charging offer towards the IMS/SIP 102 network requesting for reverse charging for all the media involved in the session.

In other embodiments if the reverse charging request from the PSTN/PLMN 103 does not indicate Transfer Mode, the IMS/SIP 102 network may still indicate the transfer accepted field as true in the response and includes the called or calling number in the response. If the IMS/SIP 102 network is the terminating network then the called number may be added in the response and if the IMS/SIP 102 network is the originating network then the calling number may be added in the response. This approach may increase the call completion rates.

In other embodiments network specific or country specific indications may be included in PSTN/PLMN 103. If a call originates from the PSTN/PLMN 103 network, a spare bit in the forward call indicators of the IAM message could carry the collect call indication. The spare bit would be interworked by the MGCF 501 to an appropriate charging offer in the invitation message. The spare bit may be bit M and collect calls are services wherein the called party will be charged for the call only after the called party agrees to accept the call from the calling party. The MGCF indicates the charging indicator in the SDP application body as ‘called’ in the charging offer sent towards the IMS/SIP 102 network. The dynamic charging information in PSTN/PLMN 103 would then be interworked to the charging indicator framework in SIP using the SDP application body. The dynamic charging information in PSTN/PLMN 103 may also be interworked using Application Transport Mechanism. For a call originating in the IMS/SIP 102 network and terminating in the PSTN/PLMN 103 network, suppression of charging to the calling user 101 may be done by interworking the backward call indicators received in the Address Complete Message (ACM) or the Call Progress Message (CPG) or the ANM ISUP messages, The MGCF 501 indicates ‘no charge’ in the response sent to the charging offer. The response sent may be the 200 OK response. The MGCF 501 indicates the charging indicator as ‘none’, in the SDP application body, in the charging offer in the 200 OK message sent towards the IMS/SIP 102 network. Any mechanism to send charge related information can be interworked to the charging offer and charging answer framework. This is a generic and flexible framework that is broad in scope and application.

There may be some exceptional scenarios which may lead to the release of the call between the two users. If the called user 104 or the network of the called user 104 is not willing to accept the request, then the called user 104 or the network of the called user 104 may send an error response to the calling user 101. When the calling user 101 receives the error response, the calling user 101 may go ahead with the call, depending on when the request was made, and the type of error response. If the calling user 101 or the called user 104 does not want to go ahead with the call then the session may be released. The error response from the IMS/SIP network may be interworked by the MGCF 501 to a release message containing the return error component and sent to PSTN/PLMN. If the timer to wait for the response from the called network expires, then the MGCF 501 may trigger a release of the session. If the state indicates that reverse charging is active and if the MGCF 501 receives another reverse charging offer from the calling user 101, then the MGCF 501 may respond with an appropriate error response. If the state indicates that reverse charging is active and if there is another reverse charging offer from the called user 104 then the MGCF 501 (or the serving application, in case the offer is sent towards IMS/SIP networks) may return an error response indicating that reverse charging was already active. If the IMS/SIP 102 network initiates a charging offer that indicates reverse charging is only for some media attributes and not for the whole session, then the MGCF 501 may reject the offer and send an error response. If the IMS/SIP 102 network initiates a charging answer that indicates reverse charging is only for some media attributes and not for the whole session, then the MGCF 501 may release the session and send an error response. If the state is ‘waiting for response’ from the called user 104 and if the called user 104 wants to end the call, then the MGCF 501 may trigger the release of the call.

Reverse charging has a number of practical usage scenarios. Embodiments disclosed herein may also be used for a call between a PSTN/PLMN 103 user and a Voice Over Internet Protocol (VOIP) user. The call may be with the VOIP/IMS/SIP users being the called users 104 and the PSTN/PLMN 103 users as the calling users 101. The call may also be with the VOIP/IMS/SIP users being the calling users 101 and a PLMN user as the called user 104. The call may also be with the VOIP/IMS/SIP users as the called user 104 and the calling user is a VOIP/IMS/SIP user and the calling user 101 network and the called user 104 network are interconnected by means of a PSTN/PLMN 103. The call may also be with the called user 104 being a PLMN user and the calling user 101 being a PSTN/PLMN 103 user and the calling user 101 network and the called user 104 network are interconnected by means of an IMS/SIP network.

Embodiments disclosed herein enables reverse charging service across different networks and scenarios when the network operators deploy Next Generation Networks (NGN) or IMS networks interworking with PSTN/PLMN networks. Charging information may be interworked between users of any kind of network and the users may be interconnected by any network or any sequence of networks. The call completion rates and the call duration rates may increase and this may not have been possible if one user runs out of credit. Initially the call may be charged to the called user 104 and subsequently the calling user 101 may be charged for the call. The calling user 101 may at a later stage in the call request the called user 104 to become the charged party for the remaining session duration. Scenarios such as multiparty calls with some of the users having different types of call diversion active may be handled depending on the network or the operator.

Additional information may be passed if there are multiple updates to the charged party. Multiple updates may have to be done in scenarios such as the calling user 101 being charged initially for the call, after a certain duration the called user is charged and after a certain duration the calling user is charged for the remainder of the session. Appropriate information may be passed over the ‘DIAMETER’ protocol interface to the charging functions. The information passed may also include the timestamp and duration and the charging functions may be the CDF (1305) and the OCS (504). Diameter is a computer networking protocol used for Authentication, Authorization and Accounting.

What is claimed is:

1. A method for enabling exchange of charging information between a calling user and a called user and negotiation of said charging information, wherein said calling user belongs to a public switched telephone network/public land mobile network (PSTN/PLMN) and said called user belongs to an Internet Protocol (IP) Multimedia Subsystem (IMS)/Session Initiation Protocol (SIP)/Voice over Internet Protocol (VoIP) network, said method comprising of said calling user or said called user sending a request to other user; wherein said request for reverse charging comprises of user to be charged, wherein said user could be said calling user or said called user and content to be charged.

2. The method, as claimed in claim 1, wherein said calling user requesting for reverse charging for a session with said called user further comprises steps of
said calling user sending a request for reverse charging for said session to said network of said calling user;
said network of said calling user sending the said request to a network controller present in network of said called user; wherein said network controller is one of
a Media Gateway Control Function (MGCF); or
a PSTN/PLMN gateway;
said network controller including said request, type of content to be charged and user to be charged in an invitation message;
said network controller sending said invitation message to a server present in network of said called user; wherein said server is one of
an Application Server; or
an S-CSCF; or
a SIP proxy server;
said server validating said invitation message against profile of said called user;
said server sending said invitation message to said called user if said called user has not subscribed for reverse charging;
said called user sending a response to said invitation message to said server, on accepting said invitation message;
said server including an indication that said called user has accepted said invitation message in said response on receiving said response from said called user or if said called user has subscribed for reverse charging;
said server sending said response to said network controller;
said network controller changing internal state to indicate activation of reverse charging, on receipt of said response;
said network controller sending a response to said network of said calling user; and
said network of said calling user sending said response to said calling user.

3. The method, as claimed in claim 1, wherein said called user requesting for reverse charging when said reverse charging is active for remaining portion of said session or for entirety of said session, further comprises steps of
said called user sending a request for reverse charging for said session to a server present in network of said called user, said request including type of content to be charged and user to be charged, and if said request for reverse charging is for entirety of said session, then said request also including an indication that entirety of said session is to be charged; wherein said server is one of
an Application Server; or
an S-CSCF; or
a SIP proxy server;
said server validating said request against profile of said called user;
said server sending said request to a network controller present in network of said called user, wherein said network controller is one of
a Media Gateway Control Function (MGCF); or
a PSTN/PLMN gateway;
said network controller sending a request for reverse charging to said network of said calling user;
said network of said calling user sending said request to said calling user;
said network of said calling user sending a response to said request to said network controller, on receiving an acceptance message from said calling user,
said network controller sending said response to said server;
said server receiving said response and accepting said response; and
said server sending said response to said called user.

4. A method for enabling exchange of charging information between a calling user and a called user and negotiation of said charging information, wherein said calling user belongs to a Internet Protocol (IP) Multimedia Subsystem (IMS)/Session Initiation Protocol (SIP)/Voice over Internet Protocol (VoIP) network and said calling user belongs to a public switched telephone network/public land mobile network (PSTN/PLMN) network or an IMS/SIP/VoIP network, said method comprising of said calling user or said called user sending a request to other user; wherein said request for reverse charging comprises of user to be charged, wherein said user could be said calling user or said called user and content to be charged.

5. The method, as claimed in claim 4, wherein said calling user requesting for reverse charging for a session with said called user further comprises steps of
said calling user sending an invitation message for reverse charging for said session to a server present in network of said calling user, wherein said invitation message comprises of type of content to be charged and user to be charged and wherein said server is one of
an Application Server; or
an S-CSCF; or
a SIP proxy server;
said server validating said invitation message;
said server sending said validated invitation message to a network controller present in said network; wherein said network controller is one of
a Media Gateway Control Function (MGCF); or
a PSTN/PLMN gateway;
said network controller sending a request for reverse charging to network of said called party;
said network controller on receipt of a response from network of said called party, sending a response message to said server present in network of said calling party, wherein said response message comprises of said response; and
said server validating said response message and sending said response message to said calling user.

6. The method, as claimed in claim 4, wherein said called user requesting for reverse charging when said reverse charging is active for remaining portion of said session or for entirety of said session further comprises steps of
said called user sending a reverse charging request for said session to said network of said called user;
said network of said called user sending said request to a network controller present in network of said calling user, and said request including an indication that entirety of said session is to be charged if said request for reverse charging is for entirety of said session, wherein said network controller is one of
a Media Gateway Control Function (MGCF); or
a PSTN/PLMN gateway;
said network controller sending a request to a server present in network of said calling user, wherein said request includes type of content to be charged and user to be charged and if said request for reverse charging is for entirety of said session then said request also including an indication that entirety of said session is to be charged, and wherein said server is one of
an Application Server; or
an S-CSCF; or
a SIP proxy server;
said server validating said request against profile of said calling user;
said server sending said request to said calling user,
said server sending a response to said request to said network controller, on receiving an acceptance message from said calling user,
said network controller receiving said response and accepting said response; and
said network controller sending said response to said called user through network of said called user.

7. The method, as claimed in claim 4, wherein said called user has subscribed for reverse charging for all incoming sessions, said method further comprising steps of
network of said called user sending an indication to a network controller present in network of said calling user, wherein said indication indicates a reverse charging request for the current session and said network controller is one of
a Media Gateway Control Function (MGCF); or
a PSTN/PLMN gateway;
said network controller sending a response to said indication;
said network controller sending a message to a server present in network of said calling user, wherein said message includes said indication and type of content to be charged and wherein said server is one of
an Application Server; or
an S-CSCF; or
a SIP proxy server;
said server checking if said calling user has to verify said indication, on receipt of said indication;
said server accepting said indication and storing said indication, if said calling user does not have to verify said indication; and
said server sending said indication to said calling user, receiving a response from said calling user and sending said response to said network controller, if said calling user has to verify said indication.

8. A method for revoking reverse charging for a session when said session is active, wherein said method comprises steps of
a first user belonging to an Internet Protocol (IP) Multimedia Subsystem (IMS)/Session Initiation Protocol (SIP)/Voice over Internet Protocol (VoIP) network sending a request to revoke reverse charging to a server present in network of said first user, wherein said first user is a calling user or a called user and said server is one of
an Application Server; or
an S-CSCF; or
a SIP proxy server;
said server forwarding said request to a network controller present in network of said first user, wherein said network controller is one of
a Media Gateway Control Function (MGCF); or
a PSTN/PLMN gateway;
said network controller checking if reverse charging is active for said session;
said network controller sending an intimation to the network of a second user belonging to a public switched telephone network/public land mobile network (PSTN/PLMN), wherein said first user is a calling user or a called user;
said network of said second user intimating the second user, on receipt of said request;
said network of said second user sending a response to said request to said network controller;
said network controller sending a response to said request to said server;
said server sending said response to said first user, and
said server initiating charging of said first user for said session.

9. A method for revoking reverse charging for a session when said session is active, wherein said method comprises steps of
a first user belonging to public switched telephone network/public land mobile network (PSTN/PLMN) sending a request for revoking reverse charging to said network of said first user, where said first user is a calling user or a called user;
said network of said first user sending said request to a network controller present in network of a second user belonging to an Internet Protocol (IP) Multimedia Subsystem (IMS)/Session Initiation Protocol (SIP)/Voice over Internet Protocol (VoIP) network, wherein said second user is a calling user or a called user and said network controller is one of
a Media Gateway Control Function (MGCF); or
a PSTN/PLMN gateway;
said network controller forwarding said request to a server present in network of said second user, wherein said server comprises one of
an Application Server; or
an S-CSCF; or
a SIP proxy server;
said server informing said second user of said request, on receipt of said request;
said server initiating charging of said second user for said session on receipt of a confirmation from said second user;
said server intimating said network controller of response of said second user;
said network controller intimating said response to said network of said first user;
said network of said first user intimating said response to said first user; and
said server initiating charging of said second user for said session.

10. A network controller, said network controller belonging to an Internet Protocol (IP) Multimedia Subsystem (IMS)/Session Initiation Protocol (SIP)/Voice over Internet Protocol (VoIP) network and controlling a session between a first user and a second user, said network controller further enabling reverse charging across networks and further comprising at least one means adapted for
including type of content to be charged and user to be charged in an invitation message, when a reverse charging request has been received from a first user;
sending said invitation message to said second user, and
triggering activation of reverse charging for a session between said first user and said second user, on receipt of a response from said second user.

11. The network controller, as claimed in claim 10, wherein said network controller is adapted to interact with said first user through a server and interact with said second user belonging to PSTN/PLMN network through said PSTN/PLMN network, wherein said first user belongs to an IMS/SIP/VoIP network and wherein said server comprises one of
an Application Server; or
an S-CSCF; or
a SIP proxy server.

12. A server, said server belonging to an Internet Protocol (IP) Multimedia Subsystem (IMS)/Session Initiation Protocol (SIP)/Voice over Internet Protocol (VoIP) network and interfacing in a session between a first user and a second user, said server further enabling reverse charging across networks and further comprising at least one means adapted for
validating an invitation message for reverse charging against profile of said second user, wherein said first user sends said invitation message, wherein said invitation message comprises of user to be charged wherein said user could be said first user or said second user and content to be charged;
sending said invitation message to said second user if said second user has not subscribed for reverse charging;
including an indication that said second user has accepted said invitation message in a response on receiving said response from said second user or if said second user has subscribed for reverse charging; and
sending said response to a network controller.

13. The server, as claimed in claim 12, wherein said server is adapted to inform charging functions of said reverse charging.

14. The server, as claimed in claim 12, wherein said server is adapted to initiate charging according to said response for said session on receipt of said response from said second user.
